(19) United States
(12) Patent Application Publication
(10) Pub. No.: US 2008/0316410 A1
(43) Pub. Date: Dec. 25, 2008

(54) DISPLAY DEVICE

(75) Inventors: Gen FUJII, Chigasaki (JP); Erika TAKAHASHI, Atsugi (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 12/133,160

(22) Filed: Jun. 4, 2008

(30) Foreign Application Priority Data
Jun. 8, 2007 (JP) 2007-153096

(51) Int. Cl. G02F 1/1343

(52) U.S. Cl. 349/139

(57) ABSTRACT

To provide display devices with improved image quality and reliability or display devices with a large screen at low cost with high productivity, an electrode layer containing a conductive polymer is used as an electrode layer for a display element, and the concentration of ionic impurities contained in the electrode layer containing a conductive polymer is reduced (preferably to 100 ppm or less). Ionic impurities are ionized, and easily become mobile ions, and they deteriorate a liquid crystal layer or an electroluminescent layer, which is used for a display element. Therefore, an electrode layer containing a conductive polymer, in which such ionic impurities are reduced is provided; thus, reliability of the display device can be improved.

### TECHNICAL FIELD

The present invention relates to display devices including a display element which includes electrode layers.

### BACKGROUND ART

Conductive polymers are widely used as a conductive material or an optical material for various devices in the electrical and electronics industry because of their high processability. Novel conductive polymer materials/materials of conductive polymers are developed to improve conductivity and processability of a conductive polymer for practical application.

For example, an alkali metal, a halogen, or the like is added to a conductive polymer as a dopant in order to improve conductivity (for example, see Reference 1: Japanese Published Patent Application No. 2003-346575).

### DISCLOSURE OF INVENTION

However, there has been a problem such that if the above-described conductive polymer is used for an electrode layer in a display device or the like, high reliability cannot be obtained in the display device.

Therefore, it is an object of the present invention to manufacture display devices with improved image quality and reliability or display devices with a large screen at low cost with high productivity.

In the present invention, an electrode layer used for a display element is formed using a conductive composition containing a conductive polymer in which the concentration of contained ionic impurities is reduced. Accordingly, ion impurities in the electrode layer containing a conductive polymer, which is used for the display element Thus, in the electrode layer formed in the display device, ionic impurities contained in the electrode layer can be reduced to (preferably to 100 ppm or less).

Mobile ionic impurities move in the display device and deteriorate a liquid crystal material or a light-emitting material, which is formed over the electrode layers, thereby causing display defects. If a display device includes an electrode layer containing a large amount of such ionic impurities which are a contamination source, characteristics of the display device is deteriorated and reliability is reduced.

Ionic impurities are impurities which easily form ions by ionization or dissociation and easily move. Accordingly, if the ionic impurities are cations, the ionic impurities may be an element with a small ionization energy (for example, 6 eV or less). An element with such ionization energy is, for example, lithium (Li), sodium (Na), potassium (K), cesium (Cs), rubidium (Rb), strontium (Sr), or barium (Ba).

If the ionic impurities are anions, the ionic impurities may be an anion such as a halogen ion included in an inorganic acid. For example, a substance having a pKₐ value, which is a negative decimal logarithm of an acid dissociation constant Kₐ, of 4 or less easily dissociates and easily forms an ion. Note that in this specification, pKa, which is a negative decimal logarithm of acid dissociation constant Ka, is a pKa value of the substance in an infinite dilute solution at 25° C. Fluorine (F⁻), chlorine (Cl⁻), bromine (Br⁻), iodine (I⁻), SO₄²⁻, HSO₄⁻, ClO₄⁻, NO₃⁻, or the like can be given as the above-described anions.

Further, ions with small sizes (for example, an ion which consists of 6 atoms or less) tend to have mobility and may move into display elements to be ionic impurities.

Therefore, in the present invention, an electrode layer used for a display element of the display device is manufactured using the above-described conductive composition containing a conductive polymer, in which ionic impurities are reduced, and the concentration of ion impurities contained in the electrode layer is 100 ppm or less.

When an electrode layer used in a display element of the present invention is a thin film, it preferably has a sheet resistance of 10000 Ω/square or less and a light transmittance of 70% or more with respect to light with a wavelength of 550 nm. In addition, resistivity of a conductive polymer in the electrode layer is preferably 0.1Ω·cm or less.

As a conductive polymer, a so-called π-electron conjugated conductive polymer can be used. For example, polyaniline and/or a derivative thereof, polypyrrole and/or a derivative thereof, polythiophene and/or a derivative thereof, and a copolymer of two or more of those materials can be used.

Specific examples of the conjugated conductive polymer include the following: polypyrrole, poly(3-methylpyrrole), poly(3-butylpyrrole), poly(3-octylpyrrole), poly(3-decylpyrrole), poly(3,4-dimethylpyrrole), poly(3,4-dibutylpyrrole), poly(3-hydroxypyrrole), poly(3-methyl-4-hydroxypyrrole), poly(3-methoxypyrrole), poly(3-ethoxypyrrole), poly(3-octoxypyrrole), poly(3-carboxylpyrrole), poly(3-methyl-4-carboxylpyrrole), poly(N-methylpyrrole), polythiophene, poly(3-methylthiophene), poly(3-butylthiophene), poly(3-octylthiophene), poly(3-decylthiophene), poly(3-dodecylthiophene), poly(3-methoxythiophene), poly(3-ethoxythiophene), poly(3-octoxythiophene), poly(3-carboxylthiophene), poly(3-methyl-4-carboxylthiophene), poly(3,4-ethylenedioxythiophene), polyaniline, poly(2-methylaniline), poly(2-octylaniline), poly(2-isobutylaniline), poly(3-isobutylaniline), poly(2-anilinesulfonic acid), and poly(3-anilinesulfonic acid).

An organic resin or a dopant may be added to the electrode layer including a conductive polymer. When an organic resin is added, characteristics of the film, such as film strength and the shape can be controlled and a film with a favorable shape can be formed. When a dopant is added, the electrical conductivity of the film can be controlled to improve the conductivity.

The organic resin which is added to the electrode layer including a conductive polymer may be a thermosetting resin, a thermoplastic resin, or a photocurable resin as long as the organic resin is compatible with the conductive polymer or the organic resin can be mixed and dispersed into the conductive polymer. For example, a polyester resin such as polyethylene terephthalate, polybutylene terephthalate, or polyethylene naphthalate; a polyimide resin such as polyimide or polyimide amide; a polyamide resin such as polyamide 6, polyamide 6,6, polyamide 12, or polyamide 11; a fluorine resin such as polyvinylidene fluoride, polyvinyl fluoride, polytetrafluoroethylene, ethylene tetrafluoroethylene copolymer, or polychlorotrifluoroethylene; a vinyl resin such as polyvinyl alcohol, polyvinyl ether, polyvinyl butyral, polyvinyl acetate, or polyvinyl chloride; an epoxy resin; a xylene resin; an aramid resin; a polyurethane resin; a polyurea resin; a melamine resin; a phenol-based resin; polyether; an acrylic-based resin; or a copolymer thereof can be used.

Among examples of a dopant which is added to the electrode layer including a conductive polymer, one or more of an organic acid, an organic cyano compound, or the like can be used particularly as an acceptor dopant. Examples of an organic acid include an organic carboxylic acid and an organic sulfonic acid. Examples of an organic carboxylic acid include acetic acid, benzoic acid, and phthalic acid. Examples of an organic sulfonic acid include p-toluenesulfonic acid, naphthalenesulfonic acid, alkylnaphthalenesulfonic acid, anthraquinonesulfonic acid, and dodecylbenzene sulfonate. A compound having two or more cyano groups in a conjugated bond can be used as an organic cyano compound, such as tetracyanoethylene, tetracyanoethylene oxide, tetracyanobenzene, tetracyanoquinodimethane, or tetracyanoazanaphthalene. Examples of a donor dopant include a quaternary amine compound and the like.

In this specification, a pair of electrode layers used for a display element may be referred to as a pixel electrode layer and a counter electrode layer depending on substrates on which the electrode layers are provided. Further, one of a pair of electrode layers used for a display element may be referred to as a first electrode layer, and the other as a second electrode layer. An electrode layer containing a conductive polymer in accordance with the present invention can be at least one of a pair of electrode layers used for a display element as described above, in which ionic impurities in the electrode layer containing a conductive polymer are reduced (preferably to 100 ppm or less). The electrode layer containing a conductive polymer in which ionic impurities are reduced (preferably to 100 ppm or less) may naturally be used for both of the pair of electrode layers. Thus, in this specification, a pixel electrode layer, a counter electrode layer, a first electrode layer, and a second electrode layer refer to electrode layers used for a display element.

In the present invention, an electrode layer including a conductive polymer is a thin film manufactured by a wet process using a conductive composition including a conductive polymer. An electrode layer including a conductive polymer may additionally include an organic resin, a dopant, or the like. In this case, an organic resin, a dopant, or the like is mixed into a conductive composition including a conductive polymer, which is a material of the electrode layer including a conductive polymer. In this specification, a conductive composition refers to a material for forming an electrode layer; the material includes at least a conductive polymer and optionally includes an organic resin, a dopant, or the like.

As described above, the conductive composition including a conductive polymer can be formed into a thin film by being dissolved in a solvent and subjected to a wet process as a liquid composition. In a wet process, a material for forming a thin film is dissolved in a solvent, the resulting liquid composition is deposited on a region where the film is to be formed, then the solvent is removed to perform solidification, thereby forming a thin film. In this specification, solidification refers to elimination of fluidity to keep a fixed shape.

For the wet process, any of the following methods can be employed: a spin coating method, a roll coating method, a spray method, a casting method, a dip coating method, a droplet discharge (ejection) method (an inkjet method), a dispensing method, a variety of printing methods (a method by which a film can be formed in a desired pattern, such as screen printing (mimeographing), offset (planographic) printing, relief printing, or gravure (intaglio) printing), or the like. Note that the wet process is not limited to the above-described methods as long as a liquid composition of the present invention is used.

In a wet process, a material is not scattered in a chamber, and therefore, efficiency in the use of materials is high compared with the case of employing a dry process such as a vapor deposition method or a sputtering method. Further, since film formation can be performed at atmospheric pressure, facilities such as a vacuum apparatus can be reduced. Furthermore, since the size of a substrate which is processed is not limited by the size of a vacuum chamber, a larger substrate can be used; thus, costs can be reduced and productivity can be improved. Since heat treatment needed in a wet process is performed at a temperature at which a solvent of a composition can be removed, a wet process is a so-called low temperature process. Accordingly, even substrates and materials which may degrade or deteriorate by heat treatment at a high temperature can be used.

Since a liquid composition having fluidity is used for the formation, materials can be easily mixed. For example, conductivity or processability can be improved by adding an organic resin or a dopant to the composition. In addition, such a composition sufficiently covers a region where a thin film of the composition is formed.

A thin film can be selectively formed by a drop discharge method in which a composition can be discharged to form a desired pattern, a printing method in which a composition can be transferred in a desired pattern or a desired pattern can be drawn with the composition, and the like. Therefore, less material is wasted so that a material can be used efficiently; accordingly, a production cost can be reduced. Furthermore, in the case of using such methods, processing of the shape of the thin film by a photolithography process is not required; therefore, the process steps are simplified and the productivity can be improved.

An electrode layer manufactured using a conductive composition including a conductive polymer in accordance with the present invention is an electrode layer containing a conductive polymer. In the electrode layer containing a conductive polymer, ionic impurities which contaminate a liquid crystal material, a light-emitting material, or the like which is included in a display element are reduced (preferably to 100 ppm or less). Therefore, a display device with high reliability can be manufactured using such an electrode layer.

Further, since an electrode layer of a display element can be manufactured by a wet process, efficiency in the use of materials is high. Still further, since expensive facilities such as a large vacuum apparatus can be reduced, low cost and high productivity can be achieved. Thus, according to the present invention, highly reliable display devices and electronic devices can be manufactured at low cost with improved productivity.

In a mode of a display device in accordance with the present invention, the display device includes a display element having a pair of electrode layers; at least one of the pair of electrode layers contains a conductive polymer; and concentration of ionic impurities in the electrode layer containing a conductive polymer is 100 ppm or less.

In a mode of a display device in accordance with the present invention, the display device includes a display element having a pair of electrode layers; the pair of electrode layers each contain a conductive polymer; and concentration of ionic impurities in the pair of electrode layers each containing a conductive polymer is 100 ppm or less.

In each of the above structures, when a liquid crystal element is used as a display element, the display element has a liquid crystal layer, and the pair of electrode layers used for the display element and the liquid crystal layer may be stacked with an insulating layer serving as alignment films therebetween. On the other hand, when a light emitting element is used as a display element, the display element have a structure having an electroluminescent layer, in which the pair of electrode layers used for the display element is in contact with the electroluminescent layer.

The present invention can be used for a display device that has a display function. Examples of display devices to which the invention is applied include a light-emitting display device having a light emitting element and a TFT connected together, in which the light emitting element includes a layer containing an organic substance, an inorganic substance, or a mixture of an organic substance and an inorganic substance between a pair of electrodes, which causes light emission called electroluminescence (hereinafter, also referred to as “EL”); a liquid crystal display device which uses a liquid crystal element containing a liquid crystal material as a display element; and the like. Note that a display device of the invention refers a device having a display element (such as a liquid crystal element or a light emitting element). A display device of the invention may also refer to a display panel provided with a plurality of pixels including display elements such as liquid crystal elements or EL elements and a peripheral driver circuit for driving the pixels over a substrate. Moreover, a display device of the invention may further include a flexible printed circuit (FPC), a printed wire board (PWB), an IC, a resistor element, a capacitor element, an inductor, a transistor, or the like. Moreover, a display device of the invention may include an optical sheet such as a polarizing plate or a retardation plate. Furthermore, it may include a backlight unit (which may include a light guide plate, a prism sheet, a diffusion sheet, a reflection sheet, or a light source (such as an LED or a cold cathode fluorescent lamp)).

Note that a display element and a display device can use various modes and they can include various elements. For example, a light emitting element such as an EL element (an organic EL element, an inorganic EL element, or an EL element containing an organic material and an inorganic material), a liquid crystal element, or a display medium of which contrast varies by an electromagnetic action, such as a display medium using electronic ink can be used. Note that an EL display is given as a display device using an EL element; a liquid crystal display, a transmissive liquid crystal display, a transflective liquid crystal display, and a reflective liquid crystal display are given as display devices using a liquid crystal element; and electronic paper is given as a display device using electronic ink.

In an electrode layer used for a display element manufactured using a conductive composition containing a conductive polymer in accordance with the present invention, ionic impurities which contaminate a liquid crystal material, a light-emitting material, or the like which is used for a display element are reduced to 100 ppm or less. Therefore, a display device with high reliability can be manufactured using such an electrode layer.

Further, since a wet process is employed for manufacturing an electrode layer of a display element, material utilization efficiency can be high, and a cost reduction and a productivity improvement can be achieved because expensive facilities such as a large vacuum apparatus can be reduced. Thus, in accordance with the present invention, highly reliable display devices and electronic devices can be manufactured at low cost with improved productivity.

### BRIEF DESCRIPTION OF DRAWINGS

FIGS. 1A and 1B are cross-sectional views each illustrating a display device of the present invention;

FIGS. 2A to 2C are a plan view and cross-sectional views each illustrating a display device of the present invention;

FIGS. 3A and 3B are cross-sectional views each illustrating a display device of the present invention;

FIGS. 4A and 4B are a perspective view and a cross-sectional view of a display device of the present invention;

FIG. 5 is a cross-sectional view illustrating a display device of the present invention;

FIGS. 6A and 6B are a plan view and a cross-sectional view of a display device of the present invention;

FIG. 7 illustrates a droplet discharge apparatus which can be used in a manufacturing process of a display device of the present invention;

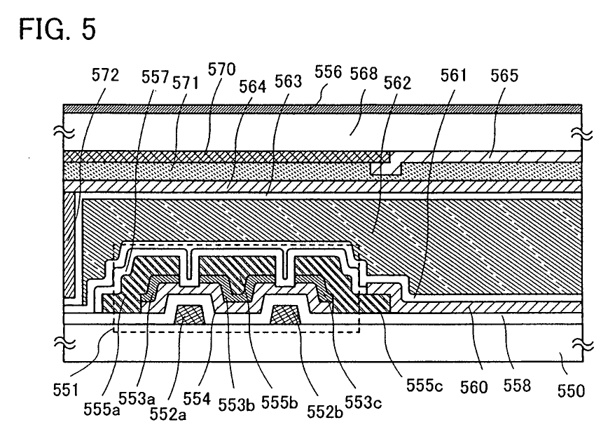

FIGS. 5A and 8B are a plan view and a cross-sectional view of a display device of the present invention;

FIGS. 9A and 9B are a plan view and a cross-sectional view of a display device of the present invention;

FIG. 10 is a cross-sectional view illustrating a display device of the present invention;

FIG. 11 is a cross-sectional view illustrating a display device of the present invention;

FIG. 12 is a cross-sectional view illustrating a display device of the present invention;

FIGS. 13A and 13B are cross-sectional views illustrating display modules of the present invention;

FIGS. 14A to 14C are cross-sectional views each illustrating a structure of a light emitting element which can be applied to the present invention

FIGS. 15A to 15C are cross-sectional views each illustrating a structure of a light emitting element which can be applied to the present invention

FIGS. 16A to 16D are cross-sectional views each illustrating a structure of a light emitting element which can be applied to the present invention

FIGS. 17A to 17C are plan views each illustrating a display device of the present invention;

FIGS. 18A and 18B are plan views illustrating a display device of the present invention;

FIG. 19 is a block diagram of illustrating a main structure of an electronic device to which the present invention is applied;

FIGS. 20A and 20B illustrate electronic devices of the present invention; and

FIGS. 21A to 21F illustrate electronic devices of the present invention;

### BEST MODE FOR CARRYING OUT THE INVENTION

Embodiment modes will be described below with reference to the drawings. However, it will be readily appreciated by those who skilled in the art that modes and details can be modified in various ways without departing from the spirit and scope of the present invention. Accordingly, the invention should not be construed as being limited to the description of the embodiment modes given below. Note that like portions and portions having the same functions may be denoted by the like reference numerals throughout the drawings and description of such portions will not be repeated.

### Embodiment Mode 1

This embodiment mode will describe an example of a display device aimed at higher image quality and higher reliability, which can be manufactured at low cost with high productivity. Specifically, this embodiment mode will describe a display device having a passive-matrix structure.

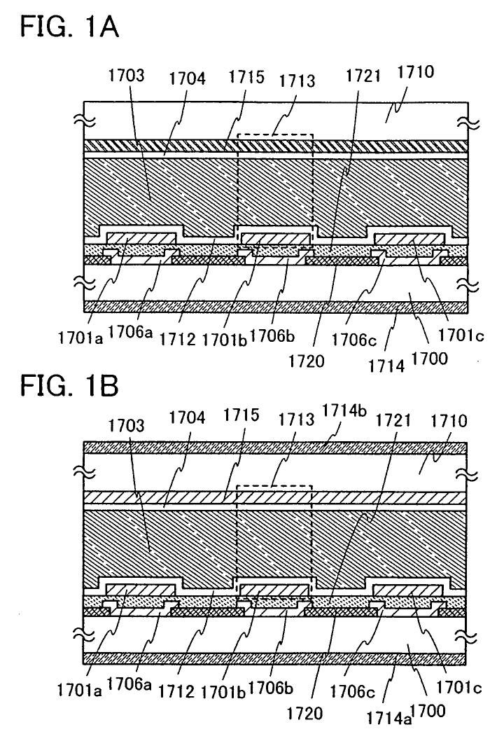

FIGS. 1A and 1B each show a passive matrix liquid crystal display device to which the present invention is applied. FIG. 1A illustrates a reflective liquid crystal display device and FIG. 1B illustrates a transmissive liquid crystal display device. In FIGS. 1A and 1B, a substrate 1700 provided with electrode layers 1701a, 1701b, and 1701c also referred to as pixel electrode layers, which are used for display elements 1713 and an insulating layer 1712 serving as an alignment film, color layers 1706a, 1706b, and 1706c serving as color filters, a polarizing plate 1714, and a light blocking layer 1720 is provided opposite to a substrate 1710 provided with an insulating layer 1704 serving as an alignment film, an electrode layer 1715 also referred to as a counter electrode layer which is used for the display elements, an insulating layer 1721, a polarizing plate 1714 (1714a, 1714b), with a liquid crystal layer 1703 therebetween.

In a display device of this embodiment mode, an electrode layer containing a conductive polymer may be used for at least one of a pair of electrode layers used for a display element, and ionic impurities in the electrode layer containing a conductive polymer is reduced (preferably to 100 ppm or less). FIG. 1A shows an example in which electrode layers containing a conductive polymer are used as the electrode layers 1701a, 1701b, and 1701c, and the concentration of ionic impurities in the electrode layers containing a conductive polymer is reduced (preferably to 100 ppm or less).

Since the display device in FIG. 1A is a reflective liquid crystal display device, the electrode layer 1705 necessarily has reflectivity. In this case, a thin metal film having reflectivity may be used, or alternatively a laminate of the thin metal film and the electrode layer containing a conductive polymer may be used.

Further, as shown in FIG. 1B, electrode layers containing a conductive polymer may be used for both of each pair of electrode layers 1701a, 1701b, and 1701c, and the electrode layer 1715 which are used for the display elements, and the concentration of ionic impurities in the electrode layers 1701a, 1701b, and 1701c, and the electrode layer 1715 which are electrode layers containing a conductive polymer is reduced (preferably to 100 ppm or less). Since the display device in FIG. 1B is a transmissive liquid crystal display device, light-transmitting electrode layers containing a conductive polymer are used for the pairs of electrode layers 1701a, 1701b, and 1701c, and the electrode layer 1715, and polarizing plates 1714a and 1714b are used.

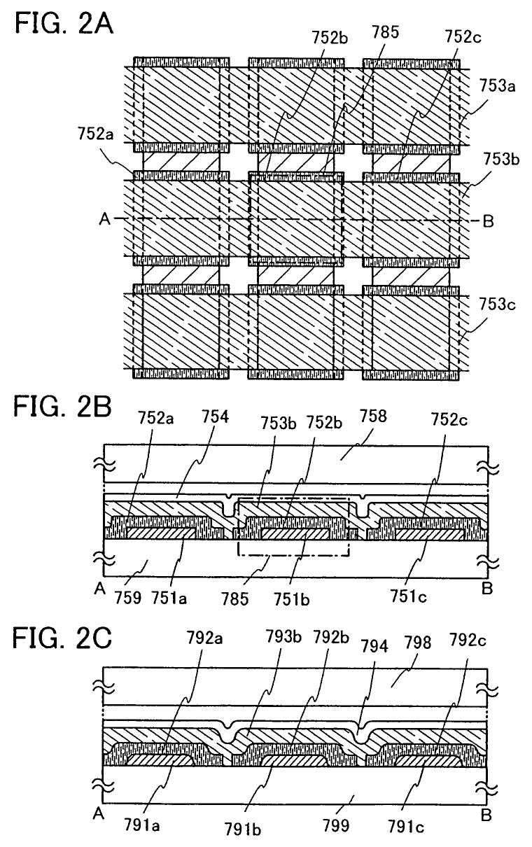

FIG. 2A to FIG. 4B each illustrate a display device having a passive matrix light emitting element (also referred to as a light emitting display device) to which the present invention is applied.

The display device includes first electrode layers 751a, 751b, and 751c which extend in a first direction, which are electrode layers used for the display elements; electroluminescent layers 752a, 752b, and 752c which are provided to cover the first electrode layers 751a, 751b, and 751c; and second electrode layers 753a, 753b, and 753c which extend in a second direction perpendicular to the first direction, which are electrode layers used for the display elements. The electroluminescent layers 752a, 752b, and 752c are provided between the first electrode layers 751a, 751b, and 751c and the second electrode layers 753a, 753b, and 753c. Further, an insulating layer 754 functioning as a protective layer is provided to cover the second electrode layers 753a, 753b, and 753c (see FIGS. 2A and 2B). Note that the cub 758 is provided as a counter substrate.

FIG. 2C is a modified example of FIG. 2B. First electrode layers 791a, 791b, and 791c; electroluminescent layers 792a, 792b, and 792c; a second electrode layer 793b; an insulating layer 794 which is a protective layer are provided over the substrate 799. Note that the substrate 798 is provided as a counter substrate. As with the first electrode layers 791a, 791b, and 791c in FIG. 2C, the first electrode layers may have a tapered shape or a curved end in which the radius of curvature changes continuously. When first electrode layers are selectively formed using a droplet discharge method or the like, they can have shapes like the first electrode layers 791a, 791b, and 791c. Curved surfaces with a curvature as above provide good coverage of stacked insulating layers or conductive layers.

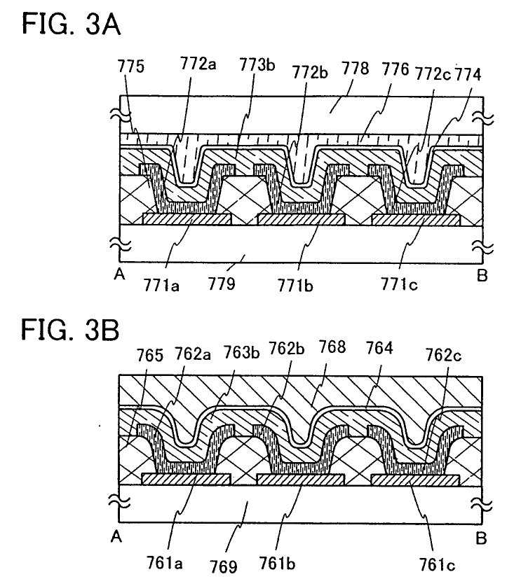

In addition, a partition wall (an insulating layer) may be formed to cover an end portion of the first electrode layer. The partition wall (insulating layer) functions like a wall which isolates one memory element from another. Each of FIGS. 3A and 3B shows a structure in which an end portion of a first electrode layer is covered with a partition wall (insulating layer).

In one example of a light emitting element shown in FIG. 3A, a partition wall (an insulating layer) 775 is formed to have a tapered shape to cover end portions of a first electrode layers 771a, 771b, and 771c. The partition wall (insulating layer) 775 is formed over the first electrode layers 771a, 771b, and 771c which are provided in contact with a substrate 779, and a substrate 778 is provided with electroluminescent layers 772a, 772b, and 772c, a second electrode layer 773b, and an insulating layer 774 with an insulating layer 776 interposed therebetween.

In one example of a light emitting element shown in FIG. 3B, a partition wall (an insulating layer) 765 has a curved shape, in which the radius of curvature changes continuously. First electrode layers 761a, 761b, and 761c, electroluminescent layers 762a, 762b, and 762c, a second electrode layer 763b, an insulating layer 764, and a protective layer 768 are provided over the substrate 769.

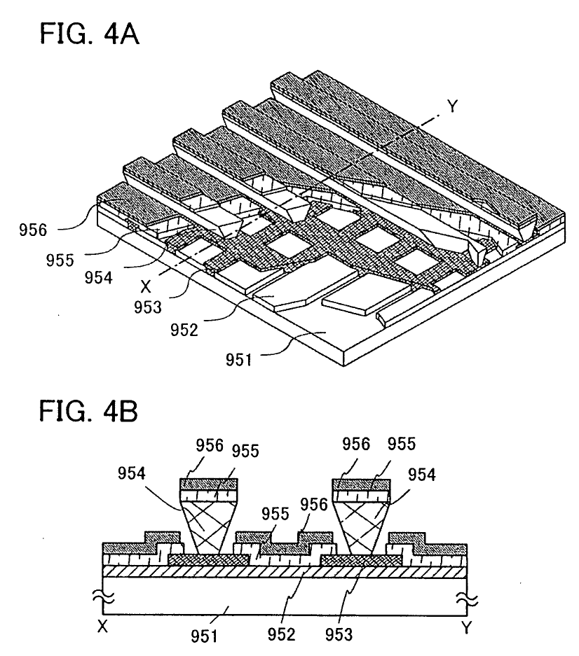

FIGS. 4A and 4B show an example of a passive matrix display device manufactured in accordance with the present invention, which has a partition wall with a shape different from FIGS. 3A and 3B. FIG. 4A of FIGS. 4A and 4B is a perspective view of a display device, and FIG. 4B is a cross-sectional view taken along line X-Y in FIG. 4A. In FIGS. 4A and 4B, an electroluminescent layer 955 which is a layer containing a light emitting substance is provided between an electrode layer 952 and an electrode layer 956, over a substrate 951. An end portion of the electrode layer 952 is covered with an insulating layer 953. Partition walls 954 are provided over the insulating layer 953. Sidewalls of each partition walls 954 are sloped so that the distance between one sidewall and the other sidewall becomes shorter toward the substrate surface. In other words, a cross-section in a short side direction of each partition walls 954 has a trapezoidal shape, for which a bottom side (a side facing a similar direction to the direction of a surface of the insulating layer 953, and is in contact with the insulating layer 953) is shorter than an upper side (a side facing a similar direction to the direction of a surface of the insulating layer 953, and is not in contact with the insulating layer 953). When the partition walls 954 are provided in such a manner, defects of the light emitting element due to static electricity or the like can be prevented.

In the display device in FIGS. 4A and 4B, the partition walls 954 have a so-called inverted tapered shape; therefore, the electroluminescent layer 955 is separated by the partition walls 954 in a self-aligned manner to be selectively formed over the electrode layer 952. Accordingly, adjacent light emitting elements are separated from each other without a shaping process by etching, and electrical faults such as shortings between the light emitting elements can be prevented. Thus, the display device shown in FIGS. 4A and 4B can be manufactured though a more simplified process.

Even in a display device having light emitting elements in any of FIG. 2A to FIG. 4B, an electrode layer containing a conductive polymer is used for at least one of a pair of electrode layers used for a light emitting element which is a display element, and ionic impurities in the electrode layer containing a conductive polymer is reduced (preferably to 100 ppm or less). Of course, electrode layers containing a conductive polymer may be used for both of each pair of the electrode layers which are used for the display element, and the concentration of ionic impurities in the electrode layers containing a conductive polymer is reduced (preferably to 100 ppm or less).

Electrode layers used for a display element according to the present invention to which electrode layers containing a conductive polymer can be used are used for the first electrode layers 751a, 751b, and 751c and the second electrode layers 753a, 753b, and 753c in FIGS. 2A and 2B; for the first electrode layers 791a, 791b, and 791c and the second electrode layer 793b in FIG. 2C; for the first electrode layers 771a, 771b, and 771c and the second electrode layer 773b in FIG. 3A; for the first electrode layers 761a, 761b, and 761c and the electrode layer 763b in FIG. 3B; for the electrode layer 952 and the electrode layer 956 in FIGS. 4A and 4B.

Mobile ionic impurities move in the display device and deteriorate a liquid crystal material or a light-emitting material, which is provided over the electrode layers, thereby causing display defects. If a display device includes an electrode layer containing a large amount of such ionic impurities which are a contamination source, characteristics of the display device is deteriorated and reliability is reduced accordingly.

Ionic impurities are impurities which easily form ions by ionization or dissociation and easily move. Accordingly, if the ionic impurities are cations, the ionic impurities may be an element with a small ionization energy (for example, 6 eV or less). An element with such ionization energy is, for example, lithium (Li), sodium (Na), potassium (K), cesium (Cs), rubidium (Rb), strontium (Sr), or barium (Ba).

If the ionic impurities are anions, the ionic impurities may be an anion such as a halogen ion included in an inorganic acid. For example, a substance having a pKₐ value, which is a negative decimal logarithm of an acid dissociation constant Kₐ, of 4 or less easily dissociates and easily forms an ion. Fluorine (F⁻), chlorine (Cl⁻), bromine (Br⁻), iodine (I⁻), SO₄²⁻, HSO₄⁻, ClO₄⁻, NO₃⁻, or the like can be given as the above-described anions.

Further, ions with small sizes (for example, an ion which consists of 6 atoms or less) tend to have mobility and may move into display elements to be ionic impurities.

Therefore, in the present invention, an electrode layer used for a display element of the display device is manufactured using the above-described conductive composition containing a conductive polymer, in which ionic impurities are reduced, so that the concentration of ion impurities contained in the electrode layer containing a conductive polymer is reduced (preferably to 100 ppm or less).

When an electrode layer used in a display element of this embodiment mode is a thin film, it preferably has a sheet resistance of 10000 Ω/square or less and a light transmittance of 70% or more with respect to light with a wavelength of 550 nm. In addition, resistivity of a conductive polymer in the electrode layer is preferably 0.1Ω·cm.

As a conductive polymer, a so-called π-electron conjugated conductive polymer can be used. For example, polyaniline and/or a derivative thereof, polypyrrole and/or a derivative thereof, polythiophene and/or a derivative thereof, and a copolymer of two or more of those materials can be used.

Specific examples of the conjugated conductive polymer include the following: polypyrrole, poly(3-methylpyrrole), poly(3-butylpyrrole), poly(3-octylpyrrole), poly(3-decylpyrrole), poly(3,4-dimethylpyrrole), poly(3,4-dibutylpyrrole), poly(3-hydroxypyrrole), poly(3-methyl-4-hydroxypyrrole), poly(3-methoxypyrrole), poly(3-ethoxypyrrole), poly(3-octoxypyrrole), poly(3-carboxylpyrrole), poly(3-methyl-4-carboxylpyrrole), poly(N-methylpyrrole), polythiophene, poly(3-methylthiophene), poly(3-butylthiophene), poly(3-octylthiophene), poly(3-decylthiophene), poly(3-dodecylthiophene), poly(3-methoxythiophene), poly(3-ethoxythiophene), poly(3-octoxythiophene), poly(3-carboxylthiophene), poly(3-methyl-4-carboxylthiophene), poly(3,4-ethylenedioxythiophene), polyaniline, poly(2-methylaniline), poly(2-octylaniline), poly(2-isobutylaniline), poly(3-isobutylaniline), poly(2-anilinesulfonic acid), and poly(3-anilinesulfonic acid).

An organic resin or a dopant may be added to the electrode layer including a conductive polymer. When an organic resin is added, characteristics of the film, such as film strength and the shape can be controlled and a film with a favorable shape can be formed. When a dopant is added, the electrical conductivity of the film can be controlled to improve the conductivity.

The organic resin which is added to the electrode layer including a conductive polymer may be a thermosetting resin, a thermoplastic resin, or a photocurable resin as long as the organic resin is compatible with the conductive polymer or the organic resin can be mixed and dispersed into the conductive polymer. For example, a polyester resin such as polyethylene terephthalate, polybutylene terephthalate, or polyethylene naphthalate; a polyimide resin such as polyimide or polyimide amide; a polyamide resin such as polyamide 6, polyamide 6,6, polyamide 12, or polyamide 11; a fluorine resin such as polyvinylidene fluoride, polyvinyl fluoride, polytetrafluoroethylene, ethylene tetrafluoroethylene copolymer, or polychlorotrifluoroethylene; a vinyl resin such as polyvinyl alcohol, polyvinyl ether, polyvinyl butyral, polyvinyl acetate, or polyvinyl chloride; an epoxy resin; a xylene resin; an aramid resin; a polyurethane resin; a polyurea resin; a melamine resin; a phenol-based resin; polyether; an acrylic-based resin; or a copolymer thereof can be used.

Among examples of a dopant which is added to the electrode layer including a conductive polymer, an organic acid, an organic cyano compound, or the like can be used particularly as an acceptor dopant. Examples of an organic acid include an organic carboxylic acid and an organic sulfonic acid. Examples of an organic carboxylic acid include acetic acid, benzoic acid, and phthalic acid. Examples of an organic sulfonic acid include p-toluenesulfonic acid, naphthalenesulfonic acid, alkylnaphthalenesulfonic acid, anthraquinonesulfonic acid, and dodecylbenzene sulfonate. A compound having two or more cyano groups in a conjugated bond can be used as an organic cyano compound, such as tetracyanoethylene, tetracyanoethylene oxide, tetracyanobenzene, tetracyanoquinodimethane, or tetracyanoazanaphthalene. Examples of a donor dopant include a quaternary amine compound and the like.

In this embodiment mode, an electrode layer including a conductive polymer is a thin film manufactured by a wet process using a conductive composition including a conductive polymer. An electrode layer including a conductive polymer may additionally include an organic resin, a dopant, or the like. In this case, an organic resin, a dopant, or the like is mixed into a conductive composition including a conductive polymer, which is a material of the electrode layer including a conductive polymer. In this specification, a conductive composition refers to a material for forming an electrode layer; the material includes at least a conductive polymer and optionally includes an organic resin, a dopant, or the like. In manufacturing, an electrode layer is formed of a thin film which is formed by a wet process using a liquid composition in which a conductive composition is dissolved in a solvent.

In order to form a conductive composition containing a conductive polymer, in which the concentration of ionic impurities is low, which is used for forming an electrode layer used for a display element in accordance with this embodiment mode, the ionic impurities may be removed by a purification method. The purification method may be selected from a variety of purification methods depending on the properties of a material such as an organic resin or a conductive polymer, which is contained in the conductive composition. For example, as the purification method, reprecipitation, salting-out, column chromatography (also referred to as column method), or the like can be used. In particular, column chromatography is preferable. In column chromatography, a cylindrical receptacle is filled with a filler, and a solvent in which a reaction mixture is dissolved is poured thereinto; thus, impurities can be separated utilizing difference of affinity with the filler or the size of molecules between compounds. As column chromatography, ion exchange chromatography, silica gel column chromatography, gel permeation chromatography (GPC), high performance liquid chromatography (HPLC), or the like can be used. In ion exchange chromatography, an ion exchange resin is used as a stationary phase, and a substance to be ionized into ions is separated into parts utilizing difference in electrostatic adhesion to ion exchanger.

As described above, a thin film can be formed by a wet process using a liquid composition obtained by dissolving the conductive composition including a conductive polymer in a solvent. The solvent may be dried by heat or may be dried under reduced pressure. In the case where the organic resin is a thermosetting resin, further heat treatment may be performed. In the case where the organic resin is a photocurable resin, light exposure may be performed.

For the wet process, any of the following methods can be employed: a spin coating method, a roll coating method, a spray method, a casting method, a dip coating method, a droplet discharge (ejection) method (an inkjet method), a dispensing method, a variety of printing methods (a method by which a film can be formed in a desired pattern, such as screen printing (mimeographing), offset (planographic) printing, relief printing, or gravure (intaglio) printing), or the like. Alternatively, an imprinting technique or a nanoimprinting technique with which a nanoscale three-dimensional structure can be formed using a transfer technology can be employed. Imprinting and nanoimprinting are techniques with which a minute three-dimensional structure can be formed without using a photolithography process. Note that the wet process is not limited to the above-described methods as long as a liquid composition of this embodiment mode is used.

The liquid composition can be obtained by dissolving a conductive composition in water or an organic solvent (such as an alcohol-based solvent, a ketone-based solvent, an ester-based solvent, a hydrocarbon-based solvent, an aromatic-based solvent).

A solvent in which a conductive composition dissolves is not particularly limited. A solvent in which polymer resin compounds of the foregoing conductive polymers and organic resins and/or the like dissolve may be used. For example, a conductive composition may be dissolved in any one of water, methanol, ethanol, ethylene glycol, propylene carbonate, N-methylpyrrolidone, dimethylformamide, dimethylacetamide, cyclohexanone, acetone, methyl ethyl ketone, methyl isobutyl ketone, and toluene, or a mixture thereof.

In a wet process, a material is not scattered in a chamber, and therefore, efficiency in the use of materials is high compared with the case of employing a dry process such as a vapor deposition method or a sputtering method. Further, since film formation can be performed at atmospheric pressure, facilities such as a vacuum apparatus can be reduced. Furthermore, since the size of a substrate which is processed is not limited by the size of a vacuum chamber, a larger substrate can be used; thus, costs can be reduced and productivity can be improved. Since heat treatment needed in a wet process is performed at a temperature at which a solvent of a composition can be removed, a wet process is a so-called low temperature process. Accordingly, even substrates and materials which may degrade or deteriorate by heat treatment at a high temperature can be used.

Since a liquid composition having fluidity is used for the formation, materials can be easily mixed. For example, conductivity or processability can be improved by adding an organic resin or a dopant to the composition. In addition, such a composition sufficiently covers a region where a thin film of the composition is formed.

A thin film can be selectively formed by a drop discharge method in which a composition can be discharged in a desired pattern, a printing method in which a composition can be transferred in a desired pattern or a desired pattern can be drawn with the composition, and the like. Therefore, less material is wasted so that a material can be used efficiently; accordingly, a production cost can be reduced. Furthermore, in the case of using such methods, processing of the shape of the thin film by a photolithography process is not required; therefore, the process steps are simplified and productivity can be improved.

In an electrode layer manufactured using a conductive composition including a conductive polymer in accordance with this embodiment mode, ionic impurities which contaminate a liquid crystal material or a light-emitting material is reduced (preferably to 100 ppm or less). Therefore, a display device with high reliability can be manufactured using such an electrode layer.

Further, since an electrode layer of a display element can be manufactured by a wet process, efficiency in the use of materials is high. Still further, since expensive facilities such as a large vacuum apparatus can be reduced, low cost and high productivity can be achieved. Thus, according to the present invention, highly reliable display devices and electronic devices can be manufactured at low cost with improved productivity.

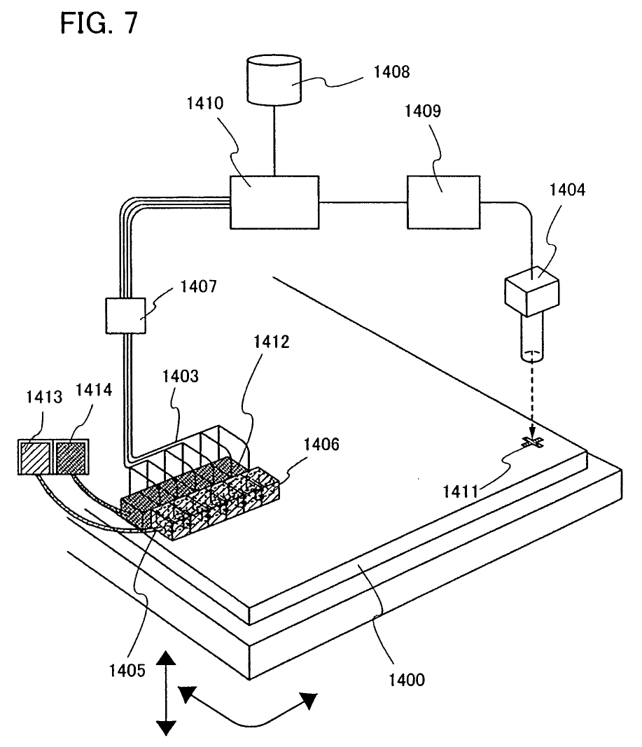

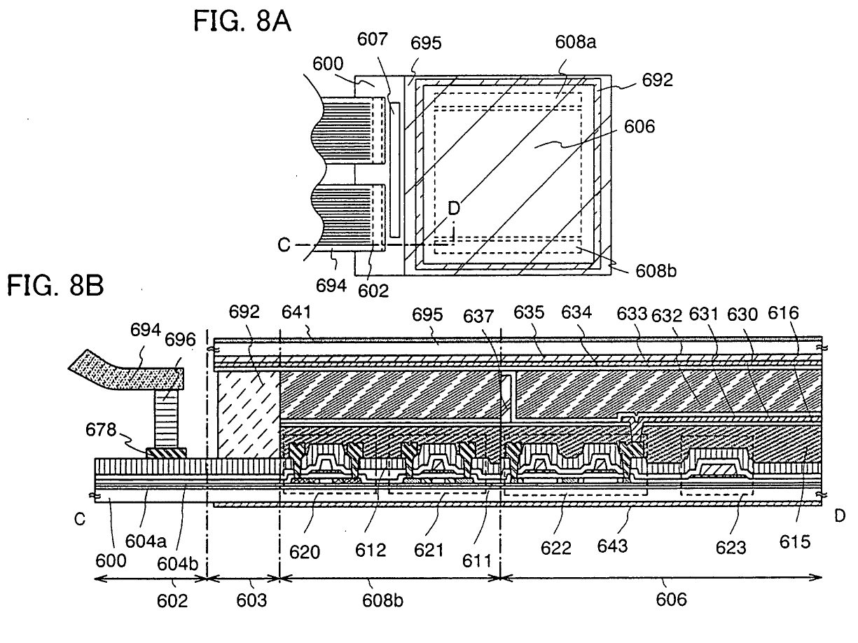

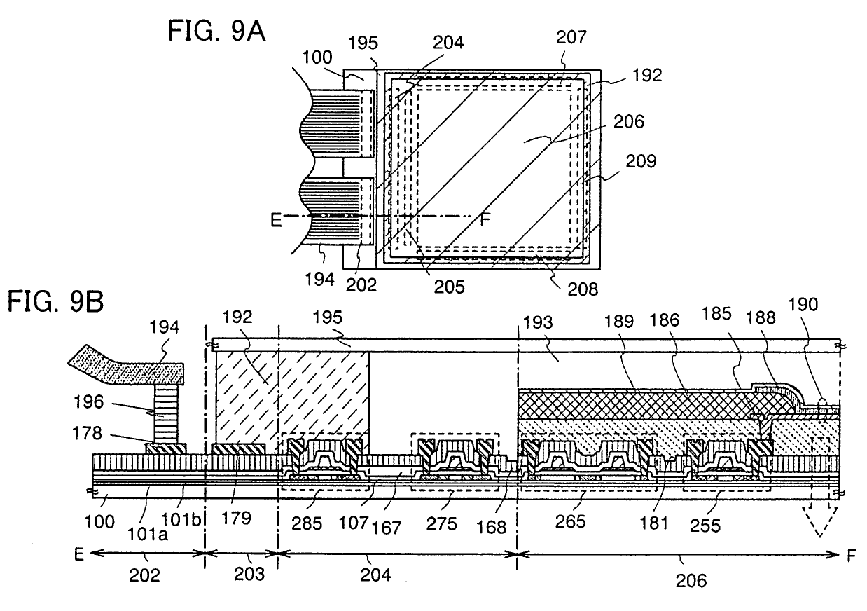

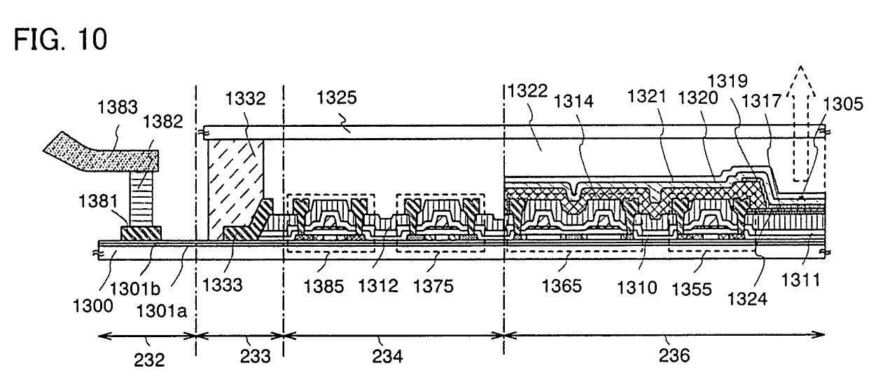

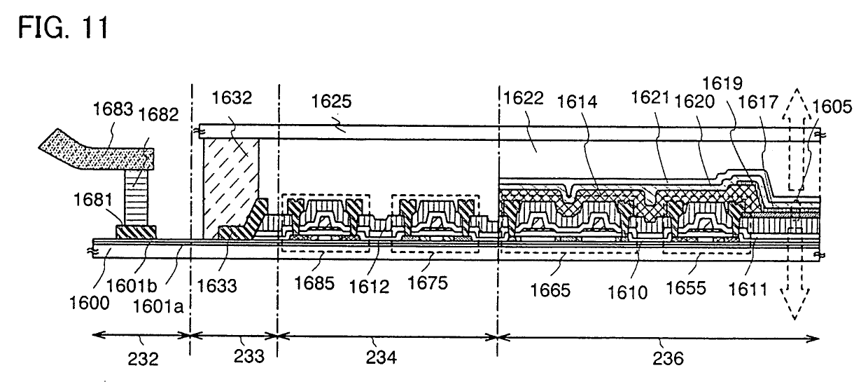

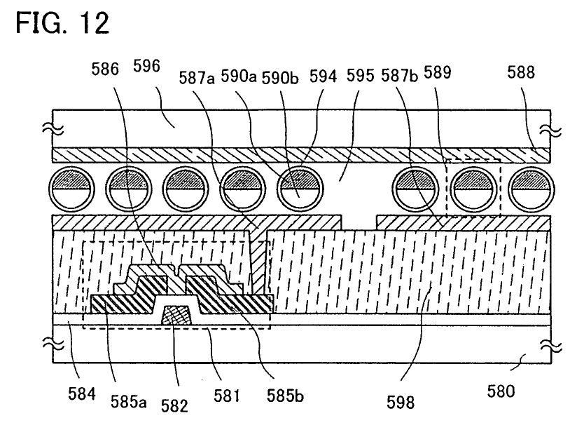

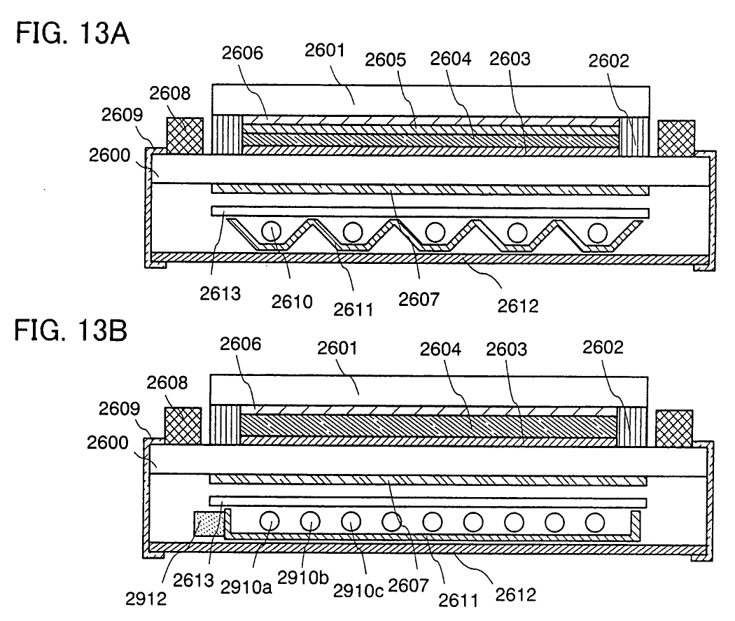

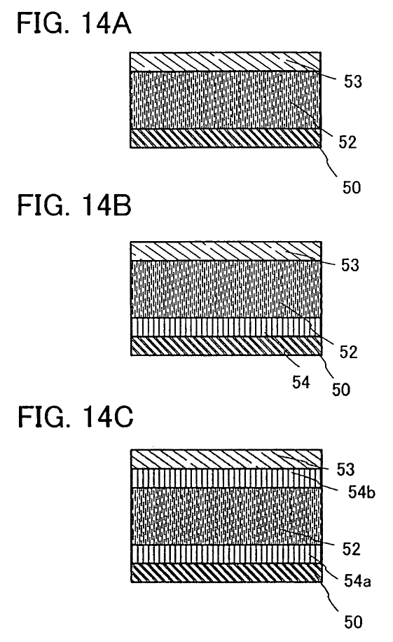

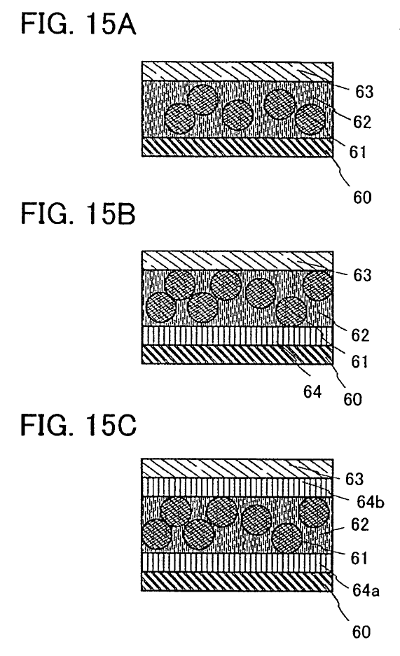

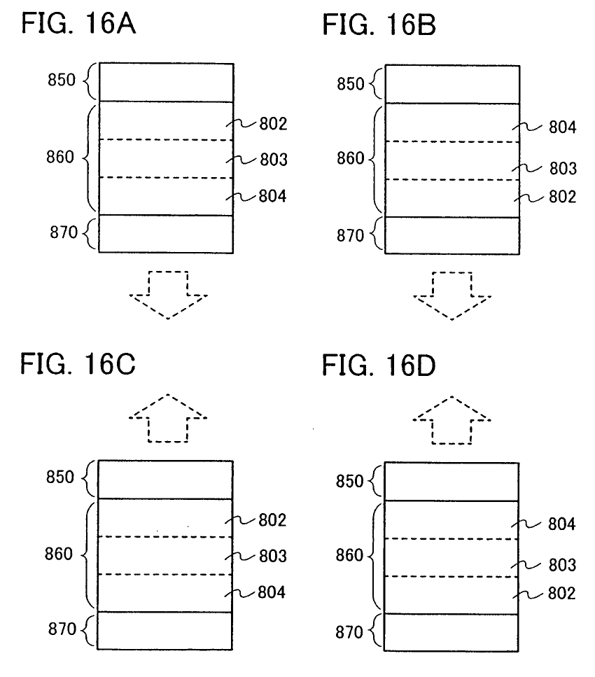

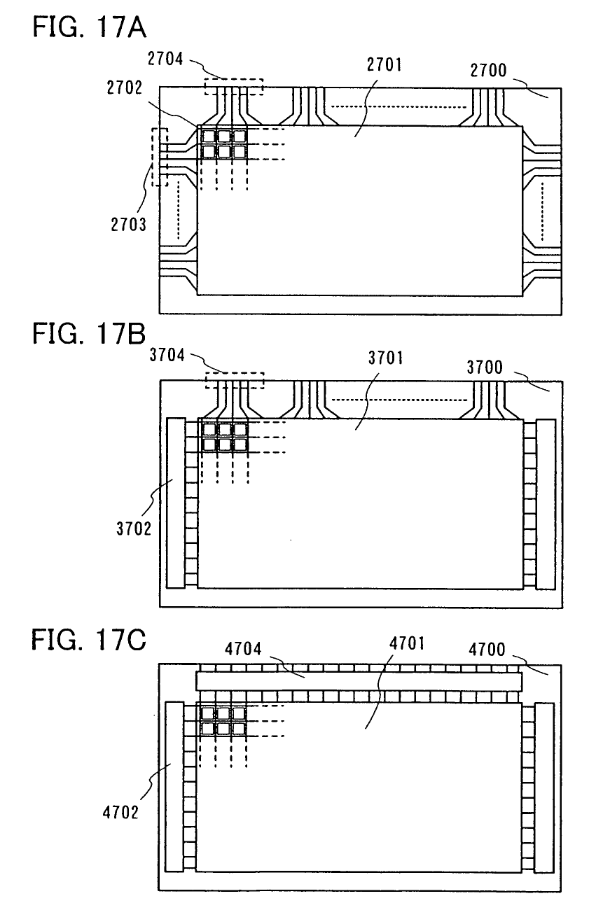

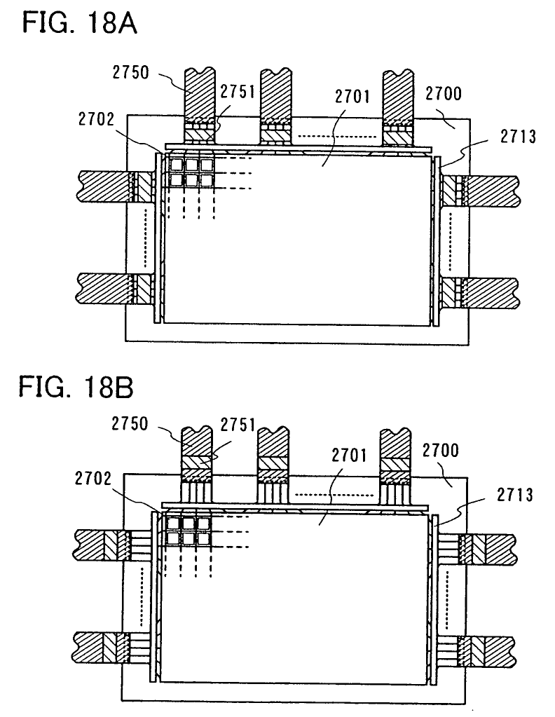

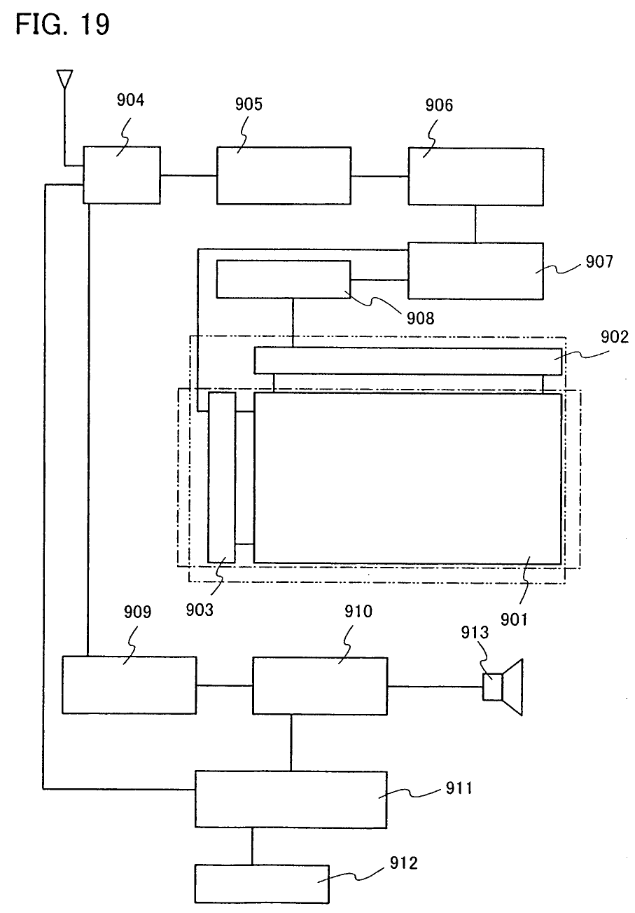

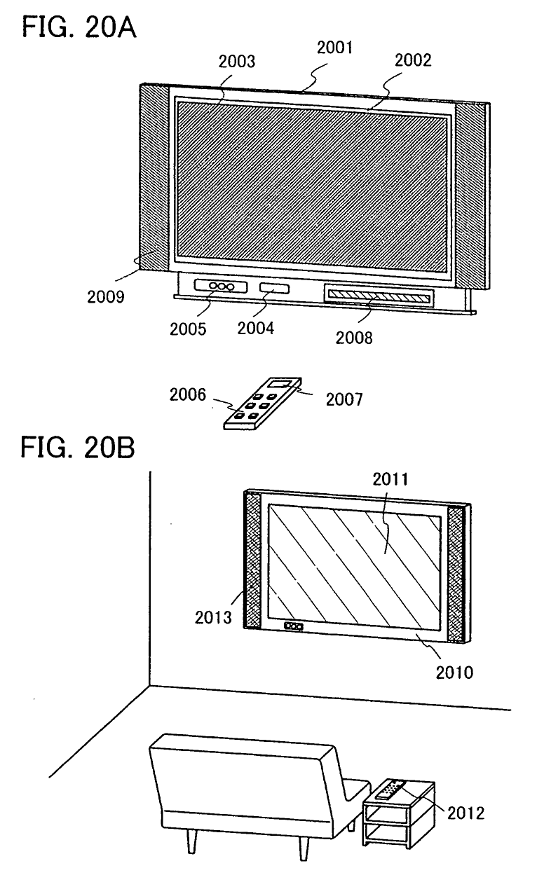

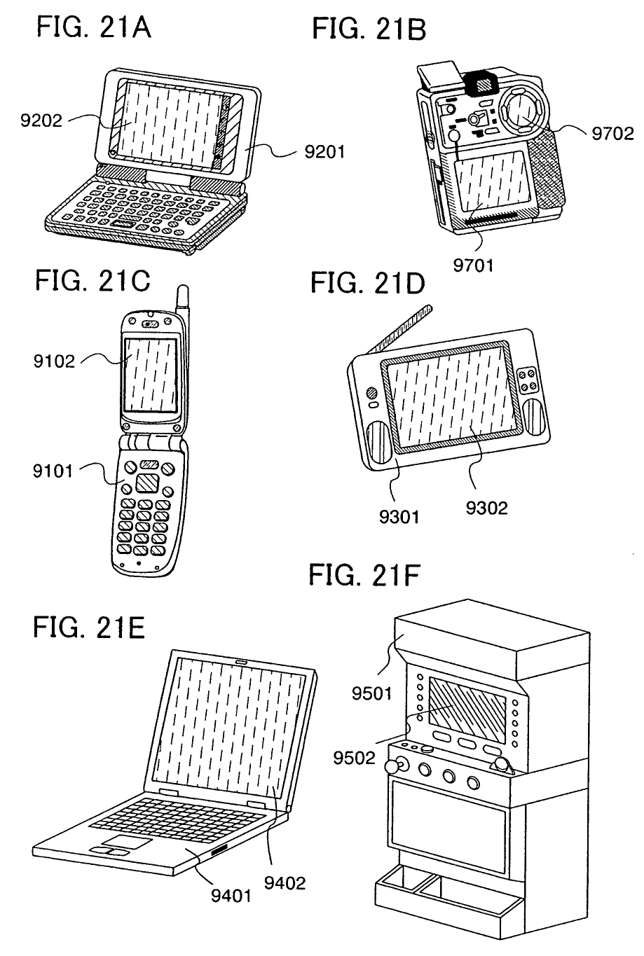

In a wet process, a droplet discharge means is used for example, which will be described with reference to FIG. 7. A droplet discharge means is a general term for an apparatus having means which discharges droplets, such as a nozzle having a discharge opening of a composition and a head having one or more nozzles.

FIG. 7 illustrates a mode of a droplet discharge apparatus used in a droplet discharge method. Each of heads 1405 and 1412 of a droplet discharge means 1403 is connected to a control means 1407, and this control means 1407 is controlled by a computer 1410, so that a preprogrammed pattern can be drawn. A position for drawing a pattern may be determined, for example, by determining a reference point by detecting a marker 1411 formed on a substrate 1400 using an imaging means 1404, an image processing means 1409, and the computer 1410. Alternatively, the reference point may be determined with reference to an edge of the substrate 1400.

As the imaging means 1404, an image sensor or the like using a charge coupled device (CCD) or a complementary metal oxide semiconductor (CMOS) can be used. Naturally, data on a pattern to be formed over the substrate 1400 is stored in a storage medium 1408, and a control signal is transmitted to the control means 1407 based on the data, so that each of the heads 1405 and 1412 of the droplet discharge means 1403 can be individually controlled. A discharged material is supplied to the heads 1405 and 1412 through pipes from a material source 1413 and a material source 1414, respectively.

Inside the head 1405, there are a space filled with a liquid material as indicated by dotted line 1406 and a nozzle serving as a discharge opening. Although not shown, the head 1412 has an internal structure similar to the head 1405. When the head 1405 and the head 1412 have nozzles with different sizes, patterns having different widths can be formed with different materials at the same time. Thus, plural kinds of materials or the like can be discharged individually from one head to draw a pattern. When a pattern is drawn in a large area, the same material can be discharged at the same time through a plurality of nozzles to improve throughput. In a case of forming a pattern on a large substrate, the heads 1405 and 1412 and a stage provided with the substrate are scanned relatively in the direction of the arrows; thus, the area of the pattern can be set freely. Accordingly, a plurality of the same patterns can be drawn over one substrate.

Further, a step of discharging the composition may be performed under reduced pressure. The substrate may be heated when the composition is discharged. After discharging the composition, either or both of steps of drying and baking are performed. Both the steps of drying and baking are performed by heat treatment. For example, drying is performed at 80° C. to 100° C. for three minutes and baking is performed at 200° C. to 550° C. for 15 minutes to 60 minutes, which are performed at different temperatures during different time periods for different purposes. The steps of drying and baking are performed under normal pressure or under reduced pressure, by laser irradiation, rapid thermal annealing, heating using a heating furnace, or the like. Note that the timing of the heat treatment and the number of heat treatment are not especially limited. The conditions for favorably perform the steps of drying and baking, such as temperature and time, depend on the material of the substrate and properties of the composition.

A glass substrate, a quartz substrate, or the like can be used as each of the substrates 758, 759, 769, 778, 779, 798, 799, 951, 1700, and 1710. Further, a flexible substrate may be used. A flexible substrate refers to a substrate which can be bent. For example, a polymer elastomer, which can be processed to be shaped similarly to plastic by plasticization at high temperatures, and has a property of an elastic body like rubber at room temperature, or the like can be used in addition to a plastic substrate made of polycarbonate, polyarylate, polyethersulfone, or the like. Alternatively, a film (made of polypropylene, polyester, vinyl, polyvinyl fluoride, vinyl chloride, or the like), an inorganic film formed by vapor deposition, or the like can be used.

As the partition walls (insulating layers) 765, 775 and 954, silicon oxide, silicon nitride, silicon oxynitride, aluminum oxide, aluminum nitride, aluminum oxynitride, or other inorganic insulating materials; acrylic acid, methacrylic acid, or a derivative thereof; a heat-resistant polymer such as polyimide, aromatic polyamide, or polybenzimidazole; or a siloxane resin may be used. Alternatively, a resin material such as a vinyl resin such as polyvinyl alcohol or polyvinylbutyral, an epoxy resin, a phenol resin, a novolac resin, an acrylic resin, a melamine resin, or a urethane resin may be used. Further, an organic material such as benzocyclobutene, parylene, fluorinated arylene ether, or polyimide, a composite material containing a water-soluble homopolymer and a water-soluble copolymer, or the like may be used. As a manufacturing method of the partition walls 765 and 775, a vapor deposition method such as plasma CVD and thermal CVD, or sputtering may be used. In addition, a droplet discharge method or a printing method (a method by which a pattern is formed, such as screen printing or offset printing) can be employed. Further, films obtained by a coating method, an SOG film, or the like may be used as the partition walls 765 and 775.

After a conductive layer, an insulating layer, or the like is formed by discharging a composition by a droplet discharge method, a surface thereof may be pressed with pressure to be planarized so that the planarity is enhanced. Examples of pressing methods may include reducing irregularities by rolling a roller-shaped object on the surface, and pressing the surface with a flat plate-shaped object. A heating step may be performed at the time of the pressing. Further, the irregularities on the surface may be removed with an air knife after the surface is softened or melted with a solvent or the like. Still further, a CMP method may be used for polishing the surface. This step may be applied for planarizing the surface when irregularities are produced in the process of forming the layers by a droplet discharge method.

An electrode layer used for a display element, which is manufactured using a conductive composition containing a conductive polymer in this embodiment mode is an electrode layer containing a conductive polymer, and in the electrode layer containing a conductive polymer, ionic impurities which contaminate a liquid crystal material, a light-emitting material, or the like which is used for a display element are reduced (preferably to 100 ppm or less). Therefore, a display device with high reliability can be manufactured using such an electrode layer.

Further, since a wet process is employed for manufacturing an electrode layer of a display element, material utilization efficiency can be high, and a cost reduction and a productivity improvement can be achieved because expensive facilities such as a large vacuum apparatus can be reduced. Thus, according to this embodiment mode of the present invention, highly reliable display devices and electronic devices can be manufactured at low cost with improved productivity.

### Embodiment Mode 2

This embodiment mode will describe an example of a display device aimed at higher image quality and higher reliability, which can be manufactured at low cost with high productivity. In this embodiment mode, a display device having a structure different from the above-described display device in Embodiment Mode 1 will be described. Specifically, the case where the display device has an active matrix structure will be described.

FIG. 5 shows a liquid crystal active matrix display device to which the present invention is applied. In FIG. 5, a substrate 550 provided with a transistor 551 having a multi-gate structure, an electrode layer 560 of a display element, and an insulating layer 561 serving as an alignment film, a substrate 568 provided with an insulating layer 563 serving as an alignment film, an electrode layer 564 of a display element, a color layer 565 serving as a color filter, a light blocking layer 570, an insulating layer 571, a spacer 572, a polarizer (also referred to as a polarizing plate) 556 face each other with a liquid crystal layer 562 sandwiched therebetween.

The transistor 551 is an example of a multi-gate channel-etch inverted staggered transistor. In FIG. 5, the transistor 551 includes gate electrode layers 552a and 552b, a gate insulating layer 558, a semiconductor layer 554, semiconductor layers 553a, 553b, and 553c having one conductivity type, and wiring layers 555a, 555b, and 555c each serving as a source electrode layer or a drain electrode layer. An insulating layer 557 is provided over the transistor 551.

While FIGS. 2A to 2C each illustrate an example of the display device in which the polarizer 556b is provided in a position outer than the substrate 568 (on the viewer side) and the color layer 565 and the electrode layer 564 of a display element are provided in a position inner than the substrate 568 in that order, the polarizer 556b may be provided in an inner position than the substrate 568. Further, the stacked structure of the polarizer and the color layer is not limited to that shown in FIGS. 2A to 2C and may be determined as appropriate depending on materials or conditions of a manufacturing process of the polarizer and the color layer.

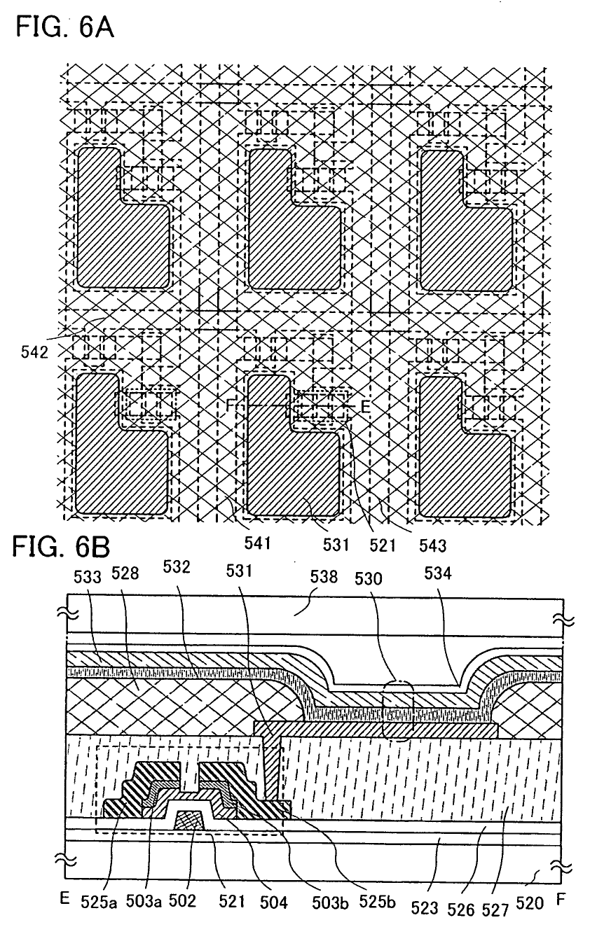

FIG. 6A is a top view of the display device, and FIG. 6B is a cross-sectional view along line E-F of FIG. 6A. Although an electroluminescent layer 532, a second electrode layer 533, and an insulating layer 534 are omitted and not illustrated in FIG. 6A, they are actually provided as illustrated in FIG. 6B.

First wirings that extend in a first direction and second wirings that extend in a second direction perpendicular to the first direction are provided over a substrate 520 having an insulating layer 523 formed as a base film. One of the first wirings is connected to a source electrode or a drain electrode of a transistor 521, and one of the second wirings is connected to a gate electrode of the transistor 521. A first electrode layer 531 is connected to a wiring layer 525b that is the source electrode or the drain electrode of the transistor 521, which is not connected to the first wiring, and a light emitting element 530 is formed to have a stacked structure of the first electrode layer 531, the electroluminescent layer 532, and the second electrode layer 533. A partition wall (insulating layer) 528 is provided between adjacent light emitting elements, and the electroluminescent layer 532 and the second electrode layer 533 are stacked over the first electrode layer and the partition wall (insulating layer) 528. An insulating layer 534 functioning as a protective layer and a substrate 538 functioning as a sealing substrate are provided over the second electrode layer 533. As the transistor 521, an inverted staggered thin film transistor is used (see FIGS. 6A and 6B). Light emitted from the light emitting element 530 is extracted from the substrate 538 side.

FIGS. 6A and 6B in this embodiment mode illustrate an example in which the transistor 521 is a channel-etched inverted staggered transistor. In FIGS. 6A and 6B, the transistor 521 includes a gate electrode layer 502, a gate insulating layer 526, a semiconductor layer 504, semiconductor layers 503a and 503b having one conductivity type, and wiring layers 525a and 525b, one of which serves as a source electrode layer and the other as a drain electrode layer. The source electrode layer or drain electrode layer does not have to be in direct electrical contact with the first electrode layer, but may be electrically connected to the first electrode layer through a wiring layer.

FIG. 12 illustrates an active matrix electronic paper as an example of a display device to which the present invention is applied. Although FIG. 12 illustrates an active matrix type, the present invention can also be applied to a passive matrix electronic paper.

The electronic paper in FIG. 12 is an example of a display device using a twisting ball display method. A twisting ball display method employs a method in which display is performed by arranging spherical particles each of which is colored separately in black and white between the first electrode layer and the second electrode layer which are electrode layers used for display elements, and generating a potential difference between the first electrode layer and the second electrode layer so as to control the directions of the spherical particles.

A transistor 581 is an inverted coplanar thin film transistor, which includes a gate electrode layer 582, a gate insulating layer 584, wiring layers 585a and 585b, and a semiconductor layer 586. The wiring layer 585b is electrically connected to the first electrode layer 587a in an opening formed in an insulating layer 598. Between the first electrode layers 587a and 587b and the second electrode layer 588, spherical particles 589, each of which includes a black region 590a and a white region 590b, and a cavity 594 filled with liquid around the black region 590a and the white region 590b, are provided. A space around the spherical particle 589 is filled with a filler 595 such as a resin (see FIG. 12).

As an alternative to a twisting ball, an electrophoretic element can be used. A microcapsule having a diameter of approximately 10 μm to 200 μm is used in which a transparent liquid, positively charged white microparticles, and negatively charged black microparticles are encapsulated. In the microcapsule that is provided between the first electrode layer and the second electrode layer, when an electric field is applied by the first electrode layer and the second electrode layer, the white microparticles and the black microparticles move in opposite directions, so that white or black can be displayed. A display element using this principle is an electrophoretic display element, which is called electronic paper in general. Since the electrophoretic display element has high reflectance compared with a liquid crystal display element, an auxiliary light is unnecessary, less power is consumed, and a display portion can be recognized even in a dim place. In addition, even when power is not supplied to the display portion, an image which has been displayed once can be maintained. Accordingly, a displayed image can be stored even if a semiconductor device having a display function (which may be referred to simply as a display device or a semiconductor device provided with a display device) is distanced from an electric wave source.

Even in a display device in any of FIG. 5, FIGS. 6A and 6B, and FIG. 12, an electrode layer containing a conductive polymer is used for at least one of a pair of electrode layers used for a display element, and ionic impurities in the electrode layer containing a conductive polymer is reduced (preferably to 100 ppm or less). Of course, electrode layers containing a conductive polymer may be used for both of each pair of the electrode layers which are used for the display element, and the concentration of ionic impurities in the electrode layers containing a conductive polymer is reduced (preferably to 100 ppm or less).

Electrode layers used for a display element according to the present invention to which electrode layers containing a conductive polymer can be used are used for the electrode layer 560 and the electrode layer 564 in FIG. 5; for the first electrode layer 531 and the second electrode layer 533 in FIGS. 6A and 6B; for the first electrode layers 587a, 587b, and the second electrode layer 588 in FIG. 12.

An electrode layer containing a conductive polymer in which ionic impurities are reduced in this embodiment mode using the present invention may be manufactured using the same material through the same process as in Embodiment Mode 1; accordingly, Embodiment Mode 1 can be applied to the formation of the electrode layer.

Mobile ionic impurities move in the display device and deteriorate a liquid crystal material or a light-emitting material, which is formed over the electrode layers, thereby causing display defects. If a display device includes an electrode layer containing a large amount of such ionic impurities which are a contamination source, characteristics of the display device is deteriorated and reliability is reduced.

Ionic impurities are impurities which easily form ions by ionization or dissociation and easily move. Accordingly, if the ionic impurities are cations, the ionic impurities may be an element with a small ionization energy (for example, 6 eV or less). An element with such ionization energy is, for example, lithium (Li), sodium (Na), potassium (K), cesium (Cs), rubidium (Rb), strontium (Sr), or barium (Ba).

If the ionic impurities are anions, the ionic impurities may be an anion such as a halogen ion included in an inorganic acid. For example, a substance having a pKₐ, value, which is a negative decimal logarithm of an acid dissociation constant Kₐ, of 4 or less easily dissociates and easily forms an ion. Fluorine (F), chlorine (Cl⁻), bromine (Br⁻), iodine (I⁻), SO₄²⁻, HSO₄⁻, ClO₄⁻, NO₃⁻, or the like can be given as the above-described anions.

Further, ions with small sizes (for example, an ion which consists of 6 atoms or less) tend to have mobility and may move into display elements to be ionic impurities.

Therefore, in the present invention, an electrode layer used for a display element of the display device is manufactured using the above-described conductive composition containing a conductive polymer, in which ionic impurities are reduced, so that the concentration of ion impurities contained in the electrode layer containing a conductive polymer is reduced (preferably to 100 ppm or less).

When an electrode layer used in a display element of this embodiment mode is a thin film, it preferably has a sheet resistance of 10000 Ω/square or less and a light transmittance of 70% or more with respect to light with a wavelength of 550 nm. In addition, resistivity of a conductive polymer in the electrode layer is preferably 0.1Ω·cm or less.

As a conductive polymer, a so-called π-electron conjugated conductive polymer can be used. For example, polyaniline and/or a derivative thereof, polypyrrole and/or a derivative thereof, polythiophene and/or a derivative thereof, and a copolymer of two or more of those materials can be used.

An organic resin or a dopant may be added to the electrode layer including a conductive polymer. When an organic resin is added, characteristics of the film, such as film strength and the shape can be controlled and a film with a favorable shape can be formed. When a dopant is added, the electrical conductivity of the film can be controlled to improve the conductivity.

The organic resin which is added to the electrode layer including a conductive polymer may be a thermosetting resin, a thermoplastic resin, or a photocurable resin as long as the organic resin is compatible with the conductive polymer or the organic resin can be mixed and dispersed into the conductive polymer.

Among examples of a dopant which is added to the electrode layer including a conductive polymer, an organic acid, an organic cyano compound, or the like can be used particularly as an acceptor dopant. Further, examples of a donor dopant include a quaternary amine compound and the like.

In order to form a conductive composition containing a conductive polymer, in which the concentration of ionic impurities is low, which is used for forming an electrode layer used for a display element in accordance with this embodiment mode, the ionic impurities may be removed by a purification method. The purification method may be performed as in Embodiment Mode.

As described above, a thin film can be formed by a wet process using a liquid composition obtained by dissolving the conductive composition including a conductive polymer in a solvent. The solvent may be dried by heat or may be dried under reduced pressure. In the case where the organic resin is a thermosetting resin, further heat treatment may be performed. In the case where the organic resin is a photocurable resin, light exposure may be performed.

The liquid composition can be obtained by dissolving a conductive composition in water or an organic solvent (such as an alcohol-based solvent, a ketone-based solvent, an ester-based solvent, a hydrocarbon-based solvent, an aromatic-based solvent). A solvent in which a conductive composition dissolves is not particularly limited. A solvent in which polymer resin compounds of the foregoing conductive polymers and organic resins and/or the like dissolve may be used.

In a wet process, a material is not scattered in a chamber, and therefore, efficiency in the use of materials is high compared with the case of employing a dry process such as a vapor deposition method or a sputtering method. Further, since film formation can be performed at atmospheric pressure, facilities such as a vacuum apparatus can be reduced. Furthermore, since the size of a substrate which is processed is not limited by the size of a vacuum chamber, a larger substrate can be used; thus, costs can be reduced and productivity can be improved. Since heat treatment needed in a wet process is performed at a temperature at which a solvent of a composition can be removed, a wet process is a so-called low temperature process. Accordingly, even substrates and materials which may degrade or deteriorate by heat treatment at a high temperature can be used.

A thin film can be selectively formed by a drop discharge method in which a composition can be discharged to form a desired pattern, a printing method in which a composition can be transferred in a desired pattern or a desired pattern can be drawn with the composition, and the like. Therefore, less material is wasted so that a material can be used efficiently; accordingly, a production cost can be reduced. Furthermore, in the case of using such methods, processing of the shape of the thin film by a photolithography process is not required; therefore, the process steps are simplified and the productivity can be improved.

The semiconductor layer can be formed using the following material: an amorphous semiconductor (hereinafter also referred to as an “AS”) manufactured by a vapor deposition method using a semiconductor source gas typified by silane or germane or a sputtering method, a polycrystalline semiconductor formed by crystallizing an amorphous semiconductor utilizing light energy or thermal energy, a semiamorphous (also referred to as microcrystalline or microcrystal) semiconductor (hereinafter also referred to as a “SAS”), or the like. Alternatively, an organic semiconductor material may be used.

Typical examples of an amorphous semiconductor include hydrogenated amorphous silicon, and typical examples of a crystalline semiconductor include polysilicon and the like. Examples of polysilicon (polycrystalline silicon) include so-called high-temperature polysilicon that contains polysilicon as a main component and is formed at a process temperature 800° C. or more, so-called low-temperature polysilicon that contains polysilicon as a main component and is formed at a process temperature 600° C. or less, and polysilicon obtained by crystallizing amorphous silicon using an element that promotes crystallization or the like. It is needless to say that a semiamorphous semiconductor or a semiconductor containing a crystal phase in part of a semiconductor film may also be used as described above.

In the case of using a crystalline semiconductor film for the semiconductor layer, the crystalline semiconductor film may be formed by various methods (such as a laser crystallization method, a thermal crystallization method, or a thermal crystallization method using an element such as nickel which promotes crystallization).

The semiconductor layer may be doped with a small amount of an impurity element (boron or phosphorus) in order to control the threshold voltage of thin film transistors.

The gate insulating layer is formed by plasma CVD, sputtering, or the like. The gate insulating layer may be formed using a material such as an oxide material or a nitride material of silicon, which are typified by silicon nitride, silicon oxide, silicon oxynitride, and silicon nitride oxide, and may be a laminate or a single layer.

The gate electrode layer, the source electrode layer or drain electrode layer, and the wiring layer can be formed by forming a conductive film by sputtering, PVD, CVD, vapor deposition, or the like and then etching the conductive film into a desired shape. Alternatively, a conductive layer can be selectively formed in a predetermined position by a droplet discharge method, a printing method, a dispensing method, an electrolytic plating method, or the like. Moreover, a reflow process or a damascene process may be used. The source electrode layer or the drain electrode layer may be formed of a conductive material such as a metal, specifically, a material such as Ag, Au, Cu, Ni, Pt, Pd, Ir, Rh, W, Al, Cr, Nd, Ta, Mo, Cd, Zn, Fe, Ti, Zr, Ba, Si, or Ge, or an alloy or nitride thereof. Alternatively, a laminate of any of those materials may be used.

As the insulating layers 523, 526, 527, and 534, an inorganic insulating material such as silicon oxide, silicon nitride, silicon oxynitride, aluminum oxide, aluminum nitride, or aluminum oxynitride; acrylic acid, methacrylic acid, or a derivative thereof; a heat-resistant polymer such as polyimide, aromatic polyamide, or polybenzimidazole; or a siloxane resin may be used. Alternatively, a resin material such as a vinyl resin such as polyvinyl alcohol or polyvinylbutyral, an epoxy resin, a phenol resin, a novolac resin, an acrylic resin, a melamine resin, or a urethane resin may be used. Further, an organic material such as benzocyclobutene, fluorinated arylene ether, or polyimide, a composition material containing a water-soluble homopolymer and a water-soluble copolymer, or the like may be used. As a manufacturing method of the insulating layers 523, 526, 527, and 534, a vapor deposition method such as a plasma CVD method or a thermal CVD method, or a sputtering method can be used. Further, a droplet discharge method or a printing method (a method by which a pattern is formed, such as screen printing or offset printing) can be employed. A film obtained by a coating method, an SOG film, or the like may also be used.

The thin film transistor is not limited to the thin film transistor described in this embodiment mode, and it may have a single gate structure with one channel formation region, a double gate structure with two channel formation regions, or a triple gate structure with channel formation regions. In addition, a thin film transistor in a peripheral driver circuit region may have a single gate structure, a double gate structure, or a triple gate structure.

The method for manufacturing the thin film transistor described in this embodiment mode can also be applied to a top gate type (for example, a staggered type and a coplanar type), a bottom gate type (for example, an inverted coplanar type), a dual gate type having two gate electrode layers which are disposed above and below a channel formation region with gate insulating films interposed therebetween, or other structures.

An electrode layer used for a display element, which is manufactured using a conductive composition containing a conductive polymer in this embodiment mode is an electrode layer containing a conductive polymer, and in the electrode layer containing a conductive polymer, ionic impurities which contaminate a liquid crystal material, a light emitting material, or the like which is used for a display element are reduced (preferably to 100 ppm or less). Therefore, a display device with high reliability can be manufactured using such an electrode layer.

Further, since a wet process is employed for manufacturing an electrode layer of a display element, material utilization efficiency can be high, and a cost reduction and a productivity improvement can be achieved because expensive facilities such as a large vacuum apparatus can be reduced. Thus, according to this embodiment mode of the present invention, highly reliable display devices and electronic devices can be manufactured at low cost with improved productivity.

This embodiment mode can be combined with the above Embodiment Mode 1 as appropriate.

### Embodiment Mode 3

This embodiment mode will describe an example of a display device aimed at higher image quality and higher reliability, which can be manufactured at low cost with high productivity. Specifically, this embodiment mode will describe a liquid crystal display device using a liquid crystal display element as a display element.

FIG. 8A is a top view of a liquid crystal display device which is one mode of the present invention. FIG. 8B is a cross-sectional view taken along line C-D in FIG. 8A.

As shown in FIG. 8A, a pixel region 606 and driver circuit regions 608a and 608b which are scan line driver circuits are sealed between a substrate 600 and a counter substrate 695 with a sealing material 692. In addition, a driver circuit region 607 which is a signal line driver circuit including a driver IC is provided over the substrate 600. A transistor 622 and a capacitor 623 are provided in the pixel region 606, and a driver circuit including a transistor 620 and a transistor 621 is provided in the driver circuit region 608b. An insulating substrate can be used as the substrate 600 as in the above-described embodiment modes. Although there is a concern that a substrate formed of a synthetic resin generally has a low heat-resistance temperature compared with other kinds of substrates, the substrate formed of a synthetic resin may be employed by first performing manufacturing steps using a substrate with high heat resistance and then replacing the substrate with the substrate formed of a synthetic resin.

In the pixel region 606, the transistor 622 serving as a switching element is provided over the substrate 600 with a base film 604a and a base film 604b interposed therebetween. In this embodiment mode, the transistor 622 is a multi-gate thin film transistor (TFT) and includes a semiconductor layer including impurity regions that serve as source and drain regions, a gate insulating layer, a gate electrode layer having a layered structure of two layers, and a source electrode layer and a drain electrode layer. The source electrode layer or the drain electrode layer is in contact with and is electrically connected to the impurity region in the semiconductor layer and an electrode layer 630 which is also referred to a pixel electrode layer of the display element.

The impurity regions in the semiconductor layer can be formed as high concentration impurity regions or a low concentration impurity regions by controlling the concentration. Such a thin film transistor having a low-concentration impurity region is referred to as a thin film transistor having a lightly doped drain (LDD) structure. The low-concentration impurity region can be formed so as to overlap with the gate electrode. Such a thin film transistor is referred to as a thin film transistor having a gate overlapped LDD (GOLD) structure. The polarity of the thin film transistor is set to be an n-type by using phosphorus (P) or the like in the impurity region. In the case where the polarity of the thin film transistor is a p-type, boron (B) or the like may be added. After that, insulating films 611 and 612 covering the gate electrode and the like are formed. A dangling bond in a crystalline semiconductor film can be terminated by hydrogen elements mixed in the insulating film 611 (and the insulating film 612).

In order to improve planarity, an insulating film 615 and an insulating film 616 may be formed as an interlayer insulating film. For the insulating films 615 and 616, an organic material, an inorganic material, or a laminate thereof can be used. For example, the insulating films 615 and 616 can be formed using a material selected from silicon oxide, silicon nitride, silicon oxynitride, silicon nitride oxide, aluminum nitride, aluminum oxynitride, aluminum nitride oxide which contains more nitrogen than oxygen, aluminum oxide, diamond-like carbon (DLC), polysilazane, carbon containing nitrogen (CN), phosphosilicate glass (PSG), borophosphosilicate glass (BPSG), alumina, and other substances containing an inorganic insulating material. Alternatively, an organic insulating material may be used. As an organic material, either a photosensitive or non-photosensitive organic insulating material may be used; for example, polyimide, acrylic, polyamide, polyimide amide, resist, benzocyclobutene, or a siloxane resin can be used. A siloxane resin refers to a resin including a Si—O—Si bond. Siloxane has a skeletal structure formed of a bond of silicon (Si) and oxygen (O) and has an organic group containing at least hydrogen (for example, an alkyl group or an aryl group) or a fluoro group as a substituent. Siloxane may have both an organic group containing at least hydrogen and a fluoro group as a substituent.

When a crystalline semiconductor film is used, a pixel region and a driver circuit region can be formed over the same substrate. In that case, a transistor in the pixel region and a transistor in the driver circuit region 608b are formed at the same time. The transistor used in the driver circuit region 608b forms a CMOS circuit. Although a thin film transistor included in a CMOS circuit has a GOLD structure, a transistor with an LDD structure, such as the transistor 622 may be employed.

Then, an insulating layer 631 which is referred to as an alignment film is formed so as to cover the electrode layer 630 used for the display element and the insulating film 616 by a printing method or a droplet discharge method. Note that the insulating layer 631 can be selectively formed when a screen printing method or an off-set printing method is used. Then, a rubbing treatment is performed. This rubbing treatment is not necessarily performed when a certain mode of liquid crystal, for example, a VA mode is employed. An insulating layer 633 serving as an alignment film is similar to the insulating layer 631. Then, the sealing material 692 is provided by a droplet discharge method in the periphery of the region where the pixels are formed.

After that, the counter substrate 695 provided with the insulating layer 633 serving as the alignment film, an inorganic insulating film 617b, an electrode layer 634 of the display element which is also referred to as a counter electrode, a color layer 635 serving as a color filter, and a polarizer (also referred to as a polarizing plate) 641 is attached to the substrate 600 which is a TFT substrate, with a spacer 637 interposed therebetween. A liquid crystal layer 632 is provided in the space between the substrates. Since the liquid crystal display device of this embodiment mode is a transmissive liquid crystal display device, a polarizer (polarizing plate) 643 is additionally provided opposite to the substrate 600 surface side, where the elements are provided. The layered structure of the polarizer and the color layer is not limited to one shown in FIGS. 8A and 8B and may be determined as appropriate depending on materials or conditions of manufacturing processes of the polarizer and the color layer. The polarizer can be provided on the substrate with an adhesive layer. A filler may be mixed into the sealing material, and a shielding film (black matrix) or the like may be formed over the counter substrate 695. Note that the color filter or the like may be formed of materials exhibiting red (R), green (G), and blue (B) when the liquid crystal display device performs full color display. When the liquid crystal display device performs monochrome display, the color layer may be omitted or formed of a material exhibiting at least one color. Further, an anti-reflection film having an anti-reflection function may be provided on the viewer side of the display device.

Note that when RGB light emitting diodes (LEDs) or the like are located in a backlight and a field sequential method which conducts color display by time division is employed, a color filter is not provided in some cases. The black matrix is preferably provided to overlap with a transistor and a CMOS circuit in order to reduce reflection of external light by wirings of the transistor and the CMOS circuit. Note that the black matrix may be provided to overlap with the capacitor so that reflection by a metal film forming the capacitor can be prevented.

The liquid crystal layer can be formed by a dispensing method (a dripping method), or an injecting method by which liquid crystal is injected using capillary action after the substrate 600 having elements and the counter substrate 695 are attached to each other. A dripping method may be employed when a large substrate to which an injecting method is difficult to be applied is used.

The spacer may be provided by spraying particles having a size of several micrometers; however, the spacer in this embodiment mode is formed by forming a resin film over the entire surface of the substrate and etching the resin film. After coating the substrate with such a spacer material with a spinner, the spacer material is formed into a predetermined pattern by light exposure and developing treatment. Then, the material is baked at 150° C. to 200° C. with a clean oven or the like to be cured. Thus manufactured spacer can have various shapes by controlling the conditions of light exposure and developing treatment. It is preferable that the spacer have a columnar shape with a flat top so that mechanical strength of the liquid crystal display device can be ensured when the counter substrate is attached. The spacer can have a conical shape, a pyramidal shape, or the like, and there is no particular limitation.

Then, an FPC 694 which is a wiring board for connection is connected to a terminal electrode layer 678 electrically connected to the pixel region through an anisotropic conductive layer 696. The FPC 694 functions to transmit external signals or potential. Through the above-described steps, a liquid crystal display device having a display function can be manufactured.

The polarizing plate and the liquid crystal layer may be stacked with a retardation plate interposed therebetween.

Even in a display device in any of FIGS. 8A and 8B, an electrode layer containing a conductive polymer is used for at least one of a pair of electrode layers 630 and 634 which are used for a display element, and ionic impurities in the electrode layer containing a conductive polymer is reduced (preferably to 100 ppm or less). Of course, electrode layers 630 and 634 containing a conductive polymer may be used for both of each pair of the electrode layers which are used for the display element, and the concentration of ionic impurities in the electrode layers containing a conductive polymer is reduced (preferably to 100 ppm or less). Since the display device in FIGS. 8A and 8B is a transmissive liquid crystal display device, both of the pair of electrode layers 630 and 634 may be formed using light-transmitting electrode layers containing a conductive polymer, in which ionic impurities are reduced.

An electrode layer containing a conductive polymer in which ionic impurities are reduced in this embodiment mode using the present invention may be manufactured using the same material through the same process as in Embodiment Mode 1; accordingly, Embodiment Mode 1 can be applied to the formation of the electrode layer.

A liquid crystal display module can be manufactured using the display device in FIGS. 8A and 8B. FIGS. 13A and 13B each illustrates an example of a display device (a liquid crystal display module) using a TFT substrate 2600 that is manufactured according to the present invention.

FIG. 13A illustrates an example of a liquid crystal display module, in which the TFT substrate 2600 and a counter substrate 2601 are fixed to each other with a sealing material 2602, and a pixel portion 2603 including a TFT, a display element 2604 including a liquid crystal layer, a color layer 2605, and a polarizing plate 2606 are provided between the substrates to form a display region. The color layer 2605 is necessary for performing color display. In the case of the RGB system, color layers corresponding to colors of red, green, and blue are provided for each pixel. The polarizing plate 2606 and a polarizing plate 2607, and a diffusion plate 2613 are provided in an outer position than the TFT substrate 2600 and the counter substrate 2601. A light source includes a cold cathode fluorescent lamp 2610 and a reflective plate 2611. A circuit substrate 2612 is connected to a wiring circuit portion 2608 of the TFT substrate 2600 through a flexible wiring board 2609 and includes an external circuit such as a control circuit and a power supply circuit. The polarizing plate and the liquid crystal layer may be stacked with a retardation plate interposed therebetween.

The liquid crystal display module can employ a twisted nematic (TN) mode, an in-plane-switching (IPS) mode, a fringe field switching (FFS) mode, a multi-domain vertical alignment (MVA) mode, a patterned vertical alignment (PVA) mode, an axially symmetric aligned micro-cell (ASM) mode, an optical compensated birefringence (OCB) mode, a ferroelectric liquid crystal (FLC) mode, an anti ferroelectric liquid crystal (AFLC) mode, or the like.

FIG. 13B shows an example of a field sequential-LCD (FS-LCD) in which an OCB mode is applied to the liquid crystal display module of FIG. 13A. The FS-LCD performs red, green, and blue light emissions in one frame period. An image is produced by composing images using time division so that color display can be performed. In addition, emission of each color is performed using a light emitting diode, a cold cathode fluorescent lamp, or the like; therefore, a color filter is not required. Accordingly, there is no necessity to arrange color filters of three primary colors and limit a display region of each color. Display of three colors can be performed in any region. On the other hand, since light of three colors is emitted in one frame period, high-speed response of liquid crystal is necessary. An FLC mode using an FS system and an OCB mode can be applied to a display device of the present invention, so that a display device or a liquid crystal television device with high performance and high image quality can be completed.

A liquid crystal layer of the OCB mode has a so-called π-cell structure. In the π-cell structure, liquid crystal molecules are aligned so that their pretilt angles are plane-symmetric with respect to a center plane between an active matrix substrate and a counter substrate. The alignment in the π-cell structure is a splay alignment when voltage is not applied between the substrates, and shifts into a bend alignment when voltage is applied. White display is performed with this bend alignment. When voltage is further applied, liquid crystal molecules of the bend alignment are aligned perpendicular to the both substrates, so that light is not transmitted. Note that the response speed approximately ten times as high as that of a conventional TN mode can be achieved by employing the OCB mode.

Moreover, as a mode supporting to the FS system, a half V-FLC (HV-FLC) or a surface stabilized-FLC (SS-FLC) using ferroelectric liquid crystal (FLC) capable of high-speed operation, or the like can also be used. The OCB mode uses nematic liquid crystal having relatively low viscosity, and HV-FLC or SS-FLC can use smectic liquid crystal having a ferroelectric phase.

An optical response speed of the liquid crystal display module is increased by narrowing a cell gap of the liquid crystal display module. The optical response speed can also be increased by decreasing the viscosity of the liquid crystal material. The optical response speed can be further increased by an overdrive method in which applied voltage is increased (or decreased) only for a moment.

The liquid crystal display module of FIG. 13B is a transmissive liquid crystal display module, in which a red light source 2910a, a green light source 2910b, and a blue light source 2910c are provided as light sources. A control portion 2912 is provided to control the red light source 2910a, the green light source 2910b, and the blue light source 2910c to be turned on or off. The light emission of colors is controlled by the control portion 2912 and light enters the liquid crystal to compose an image using a time division method, so that color display is performed.

An electrode layer used for a display element, which is manufactured using a conductive composition containing a conductive polymer in this embodiment mode is an electrode layer containing a conductive polymer, and in the electrode layer containing a conductive polymer, ionic impurities which contaminate a liquid crystal material, a light emitting material, or the like which is used for a display element are reduced (preferably to 100 ppm or less). Therefore, a display device with high reliability can be manufactured using such an electrode layer.

Further, since a wet process is employed for manufacturing an electrode layer of a display element, material utilization efficiency can be high, and a cost reduction and a productivity improvement can be achieved because expensive facilities such as a large vacuum apparatus can be reduced. Thus, according to this embodiment mode of the present invention, highly reliable display devices and electronic devices can be manufactured at low cost with improved productivity.

This embodiment mode can be combined with Embodiment Mode 1 as appropriate.

### Embodiment Mode 4

A display device having a light emitting element can be formed according to the present invention. The light emitting element emits light by any one of bottom emission, top emission, or dual emission. This embodiment mode will describe examples of a bottom emission type in FIGS. 9A and 9B, a top emission type in FIG. 10, and a dual emission type in FIG. 11, respectively.

A display device shown in FIGS. 9A and 9B includes an element substrate 100, a thin film transistor 255, a thin film transistor 265, a thin film transistor 275, a thin film transistor 285, a first electrode layer 185, an electroluminescent layer 188, a second electrode layer 189, a filler 193, a sealing material 192, an insulating film 101a, an insulating film 101b, a gate insulating layer 107, an insulating film 167, an insulating film 168, an insulating film 181, an insulating layer 186, a sealing substrate 195, a wiring layer 179, a terminal electrode layer 178, an anisotropic conductive layer 196, and an FPC 194. The display device has an external terminal connection region 202, a sealing region 203, a peripheral driver circuit region 204, and a pixel region 206. Further, as shown in FIG. 9A that is a top view of the display device, the display device includes a peripheral driver circuit region 207 and a peripheral driver circuit region 208 which have scan line driver circuits, in addition to the peripheral driver circuit region 204 and a peripheral driver circuit region 209 which have signal line driver circuits.

The display device of FIGS. 9A and 9B is a bottom emission type, in which light is emitted from the element substrate 1600 side in the direction indicated by the arrow. Therefore, the element substrate 100, the first electrode layer 185, and the second electrode layer 189 have a light-transmitting property.

The display device shown in FIG. 11 includes an element substrate 1600, a thin film transistor 1655, a thin film transistor 1665, a thin film transistor 1675, a thin film transistor 1685, a first electrode layer 1617, light-emitting layer 1619, a second electrode layer 1620, a protective film 1621, a filter 1622, a sealing material 1632, an insulating film 1601a, an insulating film 1601b, a gate insulating layer 1610, an insulating film 1611, an insulating film 1612, an insulating layer 1614, a sealing substrate 1625, a wiring layer 1633, a terminal electrode layer 1681, an anisotropic conductive layer 1682, and an FPC 1683. The display device has an external terminal connection region 232, a sealing region 233, a peripheral driver circuit region 234, and a pixel region 236.

The display device shown in FIG. 11 has a dual emission structure, in which light is emitted through both the element substrate 1600 and the sealing substrate 1625 in the directions indicated by the arrows. Therefore, a light-transmitting electrode layer is used as each of the first electrode layer 1617 and the second electrode layer 1620.

As described above, the display device of FIG. 11 has a structure in which light emitted from a light emitting element 1605 is emitted from the both faces through both the first electrode layer 1617 and the second electrode layer 1620.

The display device of FIG. 10 has a structure of top emission in the direction of the arrow. The display device illustrated in FIG. 10 includes an element substrate 1300, a thin film transistor 1355, a thin film transistor 1365, a thin film transistor 1375, a thin film transistor 1385, a wiring layer 1324, a first electrode layer 1317, a light-emitting layer 1319, a second electrode layer 1320, a protective film 1321, a filler 1322, a sealing material 1332, an insulating film 1301a, an insulating film 1301b, a gate insulating layer 1310, an insulating film 1311, an insulating film 1312, an insulating layer 1314, a sealing substrate 1325, a wiring layer 1333, a terminal electrode layer 1381, an anisotropic conductive layer 1382, and an FPC 1383. The display device in FIG. 10 includes an external terminal connection region 232, a sealing region 233, a peripheral driver circuit region 234, and a pixel region 236.

In the display device of FIG. 10, the wiring layer 1324 that is a reflective metal layer is formed below the first electrode layer 1317. The first electrode layer 1317 that is a light-transmitting conductive film is formed over the wiring layer 1324. The wiring layer 1324 is to have reflectiveness; thus, a conductive film formed of titanium, tungsten, nickel, gold, platinum, silver, copper, tantalum, molybdenum, aluminum, magnesium, calcium, lithium, an alloy thereof, or the like may be used. It is preferable to use a substance having high reflectance in the visible light range. In addition, in the case where the first electrode layer 1317 is formed using a reflective conductive film, the wiring layer 1324 having reflectivity may be omitted.

Even in a display device in any of FIGS. 9A and 9B, FIG. 10, and FIG. 11, an electrode layer containing a conductive polymer is used for at least one of a pair of electrode layers used for a light emitting element which is a display element, and ionic impurities in the electrode layer containing a conductive polymer is reduced (preferably to 100 ppm or less). Of course, electrode layers containing a conductive polymer may be used for both of each pair of the electrode layers which are used for the display element, and the concentration of ionic impurities in the electrode layers containing a conductive polymer is reduced (preferably to 100 ppm or less).

An electrode layer containing a conductive polymer in which ionic impurities are reduced in this embodiment mode using the present invention may be manufactured using the same material through the same process as in Embodiment Mode 1, and Embodiment Mode 1 can be applied.

In this embodiment mode, a light-transmitting electrode layer containing a conductive polymer is used for the first electrode layer 185, the first electrode layer 1317, the second electrode layer 1320, the first electrode layer 1617, and the second electrode layer 1620 which are light-transmitting electrode layers, and the concentration of ionic impurities contained in the electrode layers containing a conductive polymer is reduced (preferably to 100 ppm or less).

Note that in the present invention, at least one of a pair of electrode layers used for a display element uses an electrode layer containing a conductive polymer, and the concentration of ionic impurities contained in the electrode layer containing a conductive polymer is reduced (preferably to 100 ppm or less). Therefore, in the case where one of the electrode layers is formed so as to contain a conductive polymer, the other electrode layer may be formed of a different film such as a transparent conductive film or a metal film. Since the electrode layer containing a conductive polymer is has a light-transmitting property, a reflective thin film may be used instead for an electrode layer required to be reflective or a laminate of the thin metal film and the electrode layer containing a conductive polymer may be used.

Further, an insulating layer may be provided as a passivation film (protective film) over the light emitting element. As the passivation film, a single layer of an insulating film of silicon nitride, silicon oxide, silicon oxynitride, silicon nitride oxide, aluminum nitride, aluminum oxynitride containing more oxygen than nitrogen, aluminum nitride oxide containing more nitrogen than oxygen, aluminum oxide, diamond-like carbon (DLC), or nitrogen-containing carbon; or a stack thereof may be used. Alternatively, a siloxane resin may also be used.

For example, an epoxy resin such as a liquid bisphenol-A resin, a solid bisphenol-A resin, a bromine-containing epoxy resin, a bisphenol-F resin, a bisphenol-AD resin, a phenol resin, a cresol resin, a novolac resin, a cycloaliphatic epoxy resin, an Epi-Bis type epoxy resin, a glycidyl ester resin, a glycidyl amine resin, a heterocyclic epoxy resin, or a modified epoxy resin can be used. Instead of the filler, nitrogen or the like may be encapsulated by sealing in a nitrogen atmosphere. In the case where light is extracted from a display device through the filler, the filler is required to transmit light. For example, a visible light curable epoxy resin, a UV curable epoxy resin, or a thermosetting epoxy resin may be used for the filler. The filler may be dropped in a liquid state to fill the inside of the display device. When a hygroscopic substance such as a desiccating agent is used as the filler, or the filler is doped with a hygroscopic substance, higher moisture absorbing effect can be achieved and deterioration of elements can be prevented.

It is to be noted that in this embodiment mode, a light emitting element is sealed with a glass substrate; however, a sealing treatment is a treatment for protecting a light emitting element from moisture, and one of a method for mechanically sealing the light emitting element by a cover material, a method for sealing the light emitting element with a thermosetting resin or an UV curable resin, and a method for sealing the light emitting element by a thin film having a high barrier property such as a metal oxide film or a metal nitride film is used. As the cover material, glass, ceramics, plastics, or metal can be used and the cover material is required to transmit light when light is emitted through the cover material. Further, the cover material and the substrate over which the light emitting element is formed are attached to each other with a sealing material such as a thermosetting resin or a UV curable resin and the resin is cured by heat treatment or UV irradiation to form a sealed space. It is also effective to provide a moisture-absorbing material typified by barium oxide in the sealed space. The moisture-absorbing material may be provided over the sealing material in contact therewith, or in the periphery of the partition wall so as not to block light from the light emitting element.

In addition, reflection light of light incident from the outside may be blocked by using a retardation plate or a polarizing plate. An insulating layer serving as a partition wall may be colored and used as a black matrix. This partition can be formed by a droplet discharge method, using a material formed by mixing carbon black or the like into a resin material such as polyimide. Alternatively, a stack thereof may also be used. A partition wall may be formed by discharging different materials in the same region a plurality of times by a droplet discharge method. As the retardation plate, a quarter wave plate and a half wave plate may be used and designed to control light. As the structure, the element substrate, the light emitting element, the sealing substrate (sealing material), the retardation plates (a quarter wave plate and a half wave plate), and the polarizing plate are sequentially provided, and light emitted from the light emitting element is transmitted therethrough and is emitted to the outside from the polarizing plate side. The retardation plates or the polarizing plate are provided on the light emission side and may be provided on the both sides in the case of a dual emission display device in which light is emitted from both surfaces. Further, an anti-reflective film may be provided in a position outer than the polarizing plate. Thus, higher-definition and precise images can be displayed.

Although the display device of this embodiment mode includes the circuits as described above, the present invention is not limited thereto. For example, IC chips may be mounted as the peripheral driver circuits by COG or TAB as described above. Further, one or a plurality of gate driver circuits and source driver circuits may be provided.

Furthermore, a driving method for image display of the display device in this embodiment mode is not particularly limited. For example, a dot sequential driving method, a line sequential driving method, an area sequential driving method, or the like can be used. Typically, the line sequential driving method is used, and a time division gray scale driving method or an area gray scale driving method may be appropriately used. Further, a video signal which is inputted to the source line of the display device may be an analog signal or a digital signal. The driver circuit and the like may be appropriately designed in accordance with the video signal.

An electrode layer used for a display element, which is manufactured using a conductive composition containing a conductive polymer in this embodiment mode is an electrode layer containing a conductive polymer, and in the electrode layer containing a conductive polymer, ionic impurities which contaminate a liquid crystal material, a light-emitting material, or the like which is used for a display element are reduced (preferably to 100 ppm or less). Therefore, a display device with high reliability can be manufactured using such an electrode layer.

Further, since a wet process is employed for manufacturing an electrode layer of a display element, material utilization efficiency can be high, and a cost reduction and a productivity improvement can be achieved because expensive facilities such as a large vacuum apparatus can be reduced. Thus, according to this embodiment mode of the present invention, highly reliable display devices and electronic devices can be manufactured at low cost with improved productivity.

This embodiment mode can be combined with Embodiment Mode 1 and/or Embodiment Mode 2 as appropriate.

### Embodiment Mode 5

This embodiment mode will describe an example of a display device aimed at higher image quality and higher reliability, which can be manufactured at low cost with high productivity. Specifically, a light emitting element display device using a light emitting display element as a display element will be described. In this embodiment mode, a structure of a light emitting element which can be applied as a display element of a display device of the present invention will be described with reference to FIGS. 16A to 16D.

FIGS. 16A to 16D each show an element structure of a light emitting element, in which an EL layer 860 is interposed between a first electrode layer 870 and a second electrode layer 850. The EL layer 860 includes a first layer 804, a second layer 803, and a third layer 802 as illustrated in the drawings. In FIGS. 16A to 16D, the second layer 803 is a light-emitting layer, and the first layer 804 and the third layer 802 are functional layers.

The first layer 804 is a layer functions to transport holes to the second layer 803. In FIG. 16, a hole injection layer included in the first layer 804 is a layer containing a substance having a high hole injection property. Molybdenum oxide, vanadium oxide, ruthenium oxide, tungsten oxide, manganese oxide, or the like can be used. Alternatively, the first layer 804 can be formed using phthalocyanine (abbreviated to H₂Pc); a phthalocyanine-based compound such as copper phthalocyanine (CuPc); an aromatic amine compound such as 4,4′-bis[N-(4-diphenylaminophenyl)-N-phenylamino]biphenyl (abbreviated to DPAB) or 4,4′-bis(N-[4-[N-(3-methylphenyl)-N-phenylamino]phenyl]-N-phenylamino)biphenyl (abbreviated to DNTPD); or a high-molecular-weight material such as poly(ethylene dioxythiophene)/poly(styrenesulfonic acid) (PEDOT/PSS), or the like.

Alternatively, a composite material formed by composing an organic compound and an inorganic compound can be used for the hole transporting layer included in the first layer 804. In particular, a composite material including an organic compound and an inorganic compound having an electron accepting property with respect to the organic compound has an excellent hole injection property and hole transporting property because electron transfer takes place between the organic compound and the inorganic compound, increasing the carrier density.

In a case of using a composite material formed by composing an organic compound and an inorganic compound for the first layer 804, the first layer 804 can be in ohmic contact with the first electrode layer 870; therefore, a material of the first electrode layer can be selected regardless of work function.

As the inorganic compound used for the composite material, an oxide of a transition metal is preferably used. Further, oxides of metals belonging to Groups 4 to 8 in the periodic table can be used. Specifically, it is preferable to use vanadium oxide, niobium oxide, tantalum oxide, chromium oxide, molybdenum oxide, tungsten oxide, manganese oxide, and rhenium oxide because of their high electron accepting properties. Among them, molybdenum oxide is particularly preferable because it is stable in the atmosphere and has a low hygroscopicity, and thus it is easily handled.

As the organic compound used for the composite material, various compounds such as an aromatic amine compound, a carbazole derivative, aromatic hydrocarbon, and a high-molecular-weight compound (such as oligomer, dendrimer, or polymer) can be used. The organic compound used for the composite material is preferably an organic compound having a high hole transporting property. Specifically, a substance having a hole mobility of 10⁻⁶ cm²/VS or more is preferably used. However, other materials than these materials may also be used as long as the hole transporting properties thereof are higher than the electron transporting properties thereof. The organic compounds which can be used for the composite material will be specifically shown below.

For example, the following can be represented as the aromatic amine compound: N,N′-di(p-tolyl)-N,N′-diphenyl-p-phenylenediamine (abbreviated to DTDPPA); 4,4′-bis[N-(4-diphenylaminophenyl)-N-phenylamino]biphenyl (abbreviated to DPAB); 4,4′-bis(N-{4-[N′-(3-methylphenyl)-N′-phenylamino]phenyl}-N-phenylamino)biphenyl (abbreviated to DNTPD); 1,3,5-tris[N-(4-diphenylaminophenyl)-N-phenylamino]benzene (abbreviated to DPA3B); and the like.

Specific example of the carbazole derivatives which can be used for the composite material include the following: 3-[N-(9-phenylcarbazol-3-yl)-N-phenylamino]-9-phenylcarbazole (abbreviated to PCzPCA1); 3,6-bis[N-(9-phenylcarbazol-3-yl)-N-phenylamino]-9-phenylcarbazole (abbreviated to PCzPCA2); 3-[N-(1-naphtyl)-N-(9-phenylcarbazol-3-yl)amino]-9-phenylcarbazole (abbreviated to PCzPCN1); and the like.

Further, 4,4′-di(N-carbazolyl)biphenyl (abbreviated to CBP); 1,3,5-tris[4-(N-carbazolyl)phenyl]benzene (abbreviated to TCPB); 9-[4-(N-carbazolyl)]phenyl-10-phenylanthracene (abbreviated to CzPA); 1,4-bis[4-(N-carbazolyl)phenyl]-2,3,5,6-tetraphenylbenzene; or the like can be used.

Examples of aromatic hydrocarbon which can be used for the composite material include the following: 2-tert-butyl-9,10-di(2-naphthyl)anthracene (abbreviated to t-BuDNA); 2-tert-butyl-9,10-di(1-naphthyl)anthracene; 9,10-bis(3,5-diphenylphenyl)anthracene (abbreviated to DPPA); 2-tert-butyl-9,10-bis(4-phenylphenyl)anthracene (abbreviated to t-BuDBA); 9,10-di(2-naphthyl)anthracene (abbreviated to DNA); 9,10-diphenylanthracene (abbreviated to DPAnth); 2-tert-butylanthracene (abbreviated to t-BuAnth); 9,10-bis(4-methyl-1-naphthyl)anthracene (abbreviated to DMNA); 2-tert-butyl-9,10-bis[2-(1-naphthyl)phenyl]anthracene; 9,10-bis[2-(1-naphthyl)phenyl]anthracene; 2,3,6,7-tetramethyl-9,10-di(1-naphthyl)anthracene; 2,3,6,7-tetramethyl-9,10-di(2-naphthyl)anthracene; 9,9′-bianthryl; 10,10′-diphenyl-9,9′-bianthryl; 10,10′-bis(2-phenylphenyl)-9,9′-bianthryl; 10,10′-bis[(2,3,4,5,6-pentaphenyl)phenyl]-9,9′-bianthryl; anthracene; tetracene; rubrene; perylene; 2,5,8,11-tetra(tert-butyl)perylene; and the like. Besides these compounds, pentacene, coronene, or the like can also be used. In particular, an aromatic hydrocarbon which has a hole mobility of 1×10⁻⁶ cm²/Vs or more and which has 14 to 42 carbon atoms is more preferable.

The aromatic hydrocarbon which can be used for the composite material may have a vinyl skeleton. As the aromatic hydrocarbon having a vinyl group, the following are given for example: 4,4′-bis(2,2-diphenylvinyl)biphenyl (abbreviated to DPVBi); 9,10-bis[4-(2,2-diphenylvinyl)phenyl]anthracene (abbreviated to DPVPA); and the like.

Moreover, a high-molecular-weight compound such as poly(N-vinylcarbazole) (abbreviated to PVK) or poly(4-vinyltriphenylamine) (abbreviated to PVTPA) can also be used.

As a substance forming the hole transporting layer included in the first layer 804 in FIGS. 6A to 6D, a substance having a high hole transporting property, specifically, an aromatic amine compound (that is, a compound having a benzene ring-nitrogen bond) is preferable. As the material, 4,4′-bis[N-(3-methylphenyl)-N-phenylamino]biphenyl, derivatives thereof such as 4,4′-bis[N-(1-napthyl)-N-phenylamino]biphenyl (hereinafter referred to as NPB), and star burst aromatic amine compounds such as 4,4′,4″-tris(N,N-diphenyl-amino)triphenylamine, and 4,4′,4″-tris[N-(3-methylphenyl)-N-phenylamino]triphenylamine can be widely used. These materials described here mainly are substances each having a hole mobility of 10⁻⁶ cm²/Vs or more. However, other materials than these compounds may also be used as long as the hole transporting properties thereof are higher than the electron transporting properties thereof. The hole transporting layer in the first layer 804 is not limited to a single layer, and a mixed layer of the aforementioned substances, or a laminate of two or more layers each including the aforementioned substance may be used.

The third layer 802 is a layer functions to transport and inject electrons to/from the second layer 803. An electron transporting layer included in the third layer 802 will be described with reference to In FIGS. 16A to 16D. A substance having a high electron transporting property can be used for the electron transporting layer in the third layer 802. For example, a layer including a metal complex or the like having a quinoline or benzoquinoline skeleton, such as tris(8-quinolinolato)aluminum (abbreviated to Alq), tris(4-methyl-8-quinolinolato)aluminum (abbreviated to Almq₃), bis(10-hydroxybenzo[h]quinolinato)beryllium (abbreviated to BeBq₂), or bis(2-methyl-8-quinolinolato)(4-phenylphenolato)aluminum (abbreviated to BAlq) can be used. Alternatively, a metal complex having an oxazole ligand or a thiazole-based ligand, such as bis[2-(2-hydroxyphenyl)benzoxazolato]zinc (abbreviated to Zn(BOX)₂) or bis[2-(2-hydroxyphenyl)-benzothiazolato]zinc (abbreviated to Zn(BTZ)₂) can be used. Besides the metal complexes, 2-(4-biphenylyl)-5-(4-tert-butylphenyl)-1,3,4-oxadiazole (abbreviated to PBD), 1,3-bis[5-(p-tert-butylphenyl)-1,3,4-oxadiazole-2-yl]benzene (abbreviated to OXD-7), 3-(4-biphenylyl)-4-phenyl-5-(4-tert-butylphenyl)-1,2,4-triazole (abbreviated to TAZ), bathophenanthroline (abbreviated to BPhen), bathocuproine (abbreviated to BCP), or the like can also be used. The substances described here mainly are substances each having an electron mobility of 10⁻⁶ cm²/Vs or more. The electron transporting layer may be formed using other materials than those described above as long as the materials have higher electron transporting properties than hole transporting properties. Furthermore, the electron transporting layer is not limited to a single layer, and two or more layers in which each layer is made of the aforementioned material may be stacked.

An electron injection layer included in the third layer 802 will be described with reference to FIGS. 16A to 16D. As the electron injection layer, an alkali metal, an alkaline earth metal, or a compound thereof such as lithium fluoride (LiF), cesium fluoride (CsF), or calcium fluoride (CaF₂) can be used. For example, a layer which contains substance having an electron transporting property and an alkali metal, an alkaline earth metal, or a compound thereof (Alq including magnesium (Mg) for example) can be used. It is preferable to use the layer which is made of a substance having an electron-transporting property and contains an alkali metal or an alkaline earth metal as the electron injection layer because electrons are injected from the second electrode layer 850 efficiently when the layer is used.

Next, the second layer 803 which is a light emitting layer will be described. The light emitting layer has a function of emitting light and includes an organic compound having a light emitting property. Further, the light emitting layer may include an inorganic compound. The light emitting layer may be formed using various organic compounds having a light emitting property and inorganic compounds. The thickness of the light emitting layer is preferably about 10 nm to 100 nm.

There are no particular limitations on the organic compound used for the light emitting layer as long as it has a light emitting property. For example, the following can be given: 9,10-di(2-naphthyl)anthracene (abbreviated to DNA), 9,10-di(2-naphthyl)-2-tert-butylanthracene (abbreviated to t-BuDNA), 4,4′-bis(2,2-diphenylvinyl)biphenyl (abbreviated to DPVBi), coumarin 30, coumarin 6, coumarin 545, coumarin 545T, perylene, rubrene, periflanthene, 2,5,8,11-tetra(tert-butyl)perylene (abbreviated to TBP), 9,10-diphenylanthracene (abbreviated to DPA), 5,12-diphenyltetracene, 4-(dicyanomethylene)-2-methyl-[p-(dimethylamino)styryl]-4H-pyran (abbreviated to DCM1), 4-(dicyanomethylene)-2-methyl-6-[2-(julolidin-9-yl)ethenyl]-4H-pyran (abbreviated to DCM2), and 4-(dicyanomethylene)-2,6-bis[p-(dimethylamino)styryl]-4H-pyran (abbreviated to BisDCM). Further, a compound capable of emitting phosphorescence such as bis[2-(4′,6′-difluorophenyl)pyridinato-N,C^{2′}]iridium(picolinate) (abbreviated to FIrpic), bis{2-[3′,5′-bis(trifluoromethyl)phenyl]pyridinato-N,C^{2′}}iridium(picolinate) (abbreviated to Ir(CF₃ ppy)₂(pic)), tris(2-phenylpyridinato-N,C^{2′})iridium (abbreviated to Ir(ppy)₃), bis(2-phenylpyridinato-N,C^{2′})iridium(acetylacetonate) (abbreviated to Ir(ppy)₂(acac)), bis[2-(2′-thienyl)pyridinato-N,C^{3′}]iridium(acetylacetonate) (abbreviated to Ir(thp)₂(acac)), bis(2-phenylquinolinato-N,C^{2′})iridium(acetylacetonate) (abbreviated to Ir(pq)₂(acac)), or bis[2-(2′-benzothienyl)pyridinato-N,C^{3′}]iridium(acetylacetonate) (abbreviated to Ir(btp)₂(acac)) can be used.

Further, a triplet excitation light emitting material containing a metal complex or the like may be used for the light emitting layer in addition to a singlet excitation light emitting material. For example, among pixels emitting red, green, and blue light, the pixel emitting red light whose luminance is reduced by half in a relatively short time is formed using a triplet excitation light emitting material and the other pixels are formed using a singlet excitation light emitting material. Since a triplet excitation light emitting material has a favorable light emission efficiency, less power is consumed to obtain the same luminance. In other words, when a triplet excitation light emitting material is used for the pixel emitting red light, a smaller amount of current is required to be supplied to a light emitting element; therefore, reliability can be improved. The pixel emitting red light and the pixel emitting green light may be formed using a triplet excitation light emitting material and the pixel emitting blue light may be formed using a singlet excitation light emitting material in order to achieve low power consumption. Lower power consumption can be achieved when a light emitting element emitting green light, which has high visibility to human eyes, is formed of a triplet excitation light emitting material.

Another organic compound may be further added to the light emitting layer including any of the above-described organic compounds which emit light. Examples of the organic compound that can be added are TDATA, MTDATA, m-MTDAB, TPD, NPB, DNTPD, TCTA, Alq₃, Almq₃, BeBq₂, BAlq, Zn(BOX)₂, Zn(BTZ)₂, BPhen, BCP, PBD, OXD-7, TPBI, TAZ, p-EtTAZ, DNA, t-BuDNA, and DPVBi, which are mentioned above, and 4,4′-bis(N-carbazolyl)biphenyl (abbreviated to CBP), and 1,3,5-tris[4-(N-carbazolyl)phenyl]benzene (abbreviated to TCPB), but, the present invention is not limited thereto. It is preferable that the organic compound which is added in addition to the organic compound which emits light have a larger excitation energy and be added in a larger amount than the organic compound which emits light, in order to make the organic compound emit light efficiently (thus, concentration quenching of the organic compound can be prevented). Further, as another function, the added organic compound may emit light with the organic compound which emits light (thus, white light emission or the like can be performed).

The light emitting layer may have a structure in which color display is performed by forming light emitting layers having different emission wavelength ranges in each pixel. Typically, light emitting layers corresponding to colors of R (red), G (green), and B (blue) are formed. In this case, color purity can be improved and a pixel region can be prevented from having a mirror surface (reflection can be prevented) by the provision of a filter which transmits light of an emission wavelength range of the pixel on the light-emission side of the pixel. A circularly polarizing plate or the like that has been conventionally considered to be necessary can be omitted by the provision of the filter, and the loss of light emitted from the light emitting layer can be eliminated. Further, change in color tone, which occurs when a pixel region (a display screen) is viewed obliquely, can be reduced.

Either a low-molecular-weight organic light emitting material or a high-molecular-weight organic light emitting material may be used for a material of the light emitting layer. A high-molecular-weight organic light emitting material has higher physical strength than a low-molecular-weight material and an element using the high-molecular-weight organic light emitting material has higher durability than an element using a low-molecular-weight material. In addition, since a high-molecular-weight organic light emitting material can be formed by coating, the element can be relatively easily formed.

The color of light emission is determined depending on a material forming the light emitting layer; therefore, a light emitting element which emits light of a desired color can be formed by selecting an appropriate material for the light emitting layer. As a polymer electroluminescent material which can be used for forming the light emitting layer, a polyparaphenylene-vinylene-based material, a polyparaphenylene-based material, a polythiophene-based material, a polyfluorene-based material, and the like can be given.

As the polyparaphenylene-vinylene-based material, a derivative of poly(paraphenylenevinylene) [PPV] such as poly(2,5-dialkoxy-1,4-phenylenevinylene) [RO-PPV], poly(2-(2′-ethyl-hexoxy)-5-methoxy-1,4-phenylenevinylene) [MEH-PPV], or poly(2-(dialkoxyphenyl)-1,4-phenylenevinylene) [ROPh-PPV] can be given. As the polyparaphenylene-based material, a derivative of polyparaphenylene [PPP] such as poly(2,5-dialkoxy-1,4-phenylene) [RO-PPP] or poly(2,5-dihexoxy-1,4-phenylene) can be given. As the polythiophene-based material, a derivative of polythiophene [PT] such as poly(3-alkylthiophene) [PAT], poly(3-hexylthiophen) [PHT], poly(3-cyclohexylthiophen) [PCHT], poly(3-cyclohexyl-4-methylthiophene) [PCHMT], poly(3,4-dicyclohexylthiophene) [PDCHT], poly[3-(4-octylphenyl)-thiophene] [POPT], or poly[3-(4-octylphenyl)-2,2 bithiophene] [PTOPT] can be given. As the polyfluorene-based material, a derivative of polyfluorene [PF] such as poly(9,9-dialkylfluorene) [PDAF] or poly(9,9-dioctylfluorene) [PDOF] can be given.

The inorganic compound used for the light emitting layer may be any inorganic compound as long as light emission of the organic compound is not easily quenched by the inorganic compound, and various kinds of metal oxide and metal nitride may be used. In particular, an oxide of a metal that belongs to Group 13 or 14 of the periodic table is preferable because light emission of the organic compound is not easily quenched, and specifically, aluminum oxide, gallium oxide, silicon oxide, and germanium oxide are preferable. However, the inorganic compound is not limited thereto.

Note that the light emitting layer may be formed by stacking a plurality of layers each having a combination of the organic compound and the inorganic compound, which are described above, or may further have another organic compound or inorganic compound. A layer structure of the light emitting layer can be changed, and an electrode layer for injecting electrons may be provided or light emitting materials may be dispersed, instead of provision of a specific electron injection region or light emitting region. Such a change can be permitted unless it departs from the spirit of the present invention.

A light emitting element formed using the above materials emits light by being forwardly biased. A pixel of a display device which is formed using a light emitting element can be driven by a passive matrix mode or an active matrix mode. In either case, each pixel emits light by application of forward bias thereto at a specific timing; however, the pixel is in a non-light emitting state for a certain period. Reliability of a light emitting element can be improved by application of reverse bias in the non-light emitting time. In a light emitting element, there is a deterioration mode in which light emission intensity is decreased under a constant driving condition or a deterioration mode in which a non-light emitting region is increased in the pixel and luminance seems to be decreased. However, progression of deterioration can be slowed down by performing alternating driving in which bias is applied forwardly and reversely; thus, reliability of a light emitting display device can be improved. In addition, either digital driving or analog driving can be applied.

A color filter (color layer) may be provided for a sealing substrate. The color filter (color layer) can be formed by a vapor deposition method or a droplet discharge method. High-definition display can be performed using the color filter (color layer). This is because a broad peak can be modified to be sharp in a light emission spectrum of each of RGB by the color filter (color layer).

Full color display can be performed by formation of a material emitting light of a single color and combination of the material with a color filter or a color conversion layer. The color filter (color layer) or the color conversion layer may be provided for, for example, the sealing substrate, and the sealing substrate may be attached to an element substrate.

Needless to say, display of single color light emission may be performed. For example, an area color type display device may be formed by using single color light emission. A passive matrix display portion is suitable for the area color type, which can mainly display characters and symbols.

It is necessary to select materials for the first electrode layer 870 and the second electrode layer 850 in consideration of the work function. Either the first electrode layer 870 or the second electrode layer 850 can be an anode (an electrode layer with high potential) or a cathode (an electrode layer with low potential) depending on the pixel structure. In the case where the polarity of a driving thin film transistor is a p-channel type, the first electrode layer 870 may serve as an anode and the second electrode layer 850 may serve as a cathode, as shown in FIG. 16A. In the case where the polarity of the driving thin film transistor is an n-channel type, the first electrode layer 870 may serve as a cathode and the second electrode layer 850 may serve as an anode, as shown in FIG. 16B. Materials that can be used for the first electrode layer 870 and the second electrode layer 850 are described below. It is preferable to use a material having a high work function (specifically, a material having a work function of 4.5 eV or more) for one of the first electrode layer 870 and the second electrode layer 850 which serves as an anode and a material having a low work function (specifically, a material having a work function of 3.5 eV or less) for the other electrode which serves as a cathode. However, since the first layer 804 is excellent in a hole-injection property and a hole-transporting property and the third layer 802 is excellent in an electron-injection property and an electron-transporting property, both the first electrode layer 870 and the second electrode layer 850 are scarcely restricted by a work function and various materials can be used.

The light emitting elements in FIGS. 16A and 16B each have a structure in which light is taken out from the first electrode layer 870 and thus, the second electrode layer 850 does not necessarily have a light-transmitting property. The second electrode layer 850 may be formed of a film mainly containing an element selected from titanium (Ti), nickel (Ni), tungsten (W), chromium (Cr), platinum (Pt), zinc (Zn), tin (Sn), indium (In), tantalum (Ta), aluminum (Al), copper (Cu), gold (Au), silver (Ag), magnesium (Mg), calcium (Ca), lithium (Li) or molybdenum (Mo), or an alloy material or a compound material containing any of those elements as its main component, such as titanium nitride, TiSi_{X}N_{Y}, WSi_{X}, tungsten nitride, WSi_{X}N_{Y}, or NbN; or a laminate thereof with a total thickness of 100 nm to 800 nm.

In addition, when the second electrode layer 850 is formed using a light-transmitting conductive material similarly to the material used for the first electrode layer 870, light can be taken out from the second electrode layer 850 as well, and a dual emission structure can be obtained, in which light from the light emitting element is emitted through both the first electrode layer 870 and the second electrode layer 850.

Note that the light emitting element of the present invention can have variations by changing types of the first electrode layer 870 and the second electrode layer 850.

FIG. 16B shows the case where the EL layer 860 is formed by stacking the third layer 802, the second layer 803, and the first layer 804 in that order from the first electrode layer 870 side.

FIG. 16C shows a structure in which an electrode layer having reflectivity is used for the first electrode layer 870 and an electrode having a light-transmitting property is used for the second electrode layer 850 in FIG. 16A and in which light emitted from the light emitting element is reflected by the first electrode layer 870, transmitted through the second electrode layer 850, and emitted to the outside. Similarly, FIG. 16D shows a structure in which an electrode having reflectivity is used for the first electrode layer 870 and an electrode having a light-transmitting property is used for the second electrode layer 850 in FIG. 16B and in which light emitted from the light emitting element is reflected by the first electrode layer 870, transmitted through the second electrode layer 850, and emitted to the outside.

Further, various methods can be used as a method for forming the EL layer 860 when an organic compound and an inorganic compound are mixed for the EL layer 860. For example, there is a co-evaporation method for vaporizing both an organic compound and an inorganic compound by resistance heating. Further, co-evaporation may be performed in which an inorganic compound may be vaporized by an electron beam (EB) while an organic compound is vaporized by resistance heating. Furthermore, a method for sputtering an inorganic compound while vaporizing an organic compound by resistance heating to deposit the both at the same time may also be used. Instead, the EL layer 860 may be formed by a wet method.

An electrode layer containing a conductive polymer is used for at least one of a pair of electrode layers (the first electrode layer 870 and the second electrode layer 850) used for a light emitting element which is a display element in FIGS. 16A to 16D, and the concentration of ionic impurities contained in the electrode layer containing a conductive polymer is reduced (preferably to 100 ppm or less). Of course, electrode layers containing a conductive polymer may be used for both of each pair of the electrode layers which are used for the display element, and the concentration of ionic impurities in the electrode layers containing a conductive polymer is reduced (preferably to 100 ppm or less).

An electrode layer containing a conductive polymer in which ionic impurities are reduced in this embodiment mode using the present invention may be manufactured using the same material through the same process as in Embodiment Mode 1; accordingly, Embodiment Mode 1 can be applied to the formation of the electrode layer.

In this embodiment mode, an electrode layer containing a conductive polymer is used when the first electrode layer 870 or the second electrode layer 850 is required to transmit light, and the concentration of ionic impurities in the electrode layer containing a conductive polymer is reduced (preferably 100 to ppm or less).

Note that in the present invention, at least one of a pair of electrode layers used for a display element uses an electrode layer containing a conductive polymer, and the concentration of ionic impurities contained in the electrode layer containing a conductive polymer is reduced (preferably to 100 ppm or less). Therefore, in the case where one of the electrode layers is formed so as to contain a conductive polymer, the other electrode layer may be formed of a transparent conductive film or a metal film. Since the electrode layer containing a conductive polymer is has a light-transmitting property, a reflective thin film may be used instead for an electrode layer required to be reflective or a laminate of the thin metal film and the electrode layer containing a conductive polymer may be used.

This embodiment mode can be freely combined with the above-described other embodiment modes regarding a display device including a light emitting element.

An electrode layer used for a display element, which is manufactured using a conductive composition containing a conductive polymer in this embodiment mode is an electrode layer containing a conductive polymer, and in the electrode layer containing a conductive polymer, ionic impurities which contaminate a liquid crystal material, a light-emitting material, or the like which is used for a display element are reduced (preferably to 100 ppm or less). Therefore, a display device with high reliability can be manufactured using such an electrode layer.

Further, since a wet process is employed for manufacturing an electrode layer of a display element, material utilization efficiency can be high, and a cost reduction and a productivity improvement can be achieved because expensive facilities such as a large vacuum apparatus can be reduced. Thus, according to this embodiment mode of the present invention, highly reliable display devices and electronic devices can be manufactured at low cost with improved productivity.

This embodiment mode can be combined with the above Embodiment Modes 1, 2, and 4 as appropriate.

### Embodiment Mode 6

This embodiment mode will describe an example of a display device aimed at higher image quality and higher reliability, which can be manufactured at low cost with high productivity. Specifically, a light emitting element display device using a light emitting display element as a display element will be described. In this embodiment mode, a structure of a light emitting element which can be applied as a display element of a display device of the present invention will be described with reference to FIGS. 14A to 15C.

Light emitting elements using electroluminescence can be roughly classified into light emitting elements that use an organic compound as a light emitting material and light emitting elements that use an inorganic compound as a light emitting material. In general, the former is referred to as an organic EL element, while the latter is referred to as an inorganic EL element.

Inorganic EL elements are classified into a dispersion-type inorganic EL element and a thin-film-type inorganic EL element according to their element structures. The difference between the two EL elements lies in that the former dispersion-type inorganic EL element includes an electroluminescent layer in which particulate light emitting materials are dispersed in a binder, while the latter thin-film-type inorganic EL element includes an electroluminescent layer formed of a thin film of a light emitting material. Although the two light emitting elements are different in the above points, they have a common characteristic in that both require electrons that are accelerated by a high electric field. As types of light-emission mechanisms, there are luminescence obtained by donor-acceptor recombination which utilizes a donor level and an acceptor level, and local luminescence which utilizes inner-shell electron transition of metal ions. In general, a dispersion-type inorganic EL element exhibits luminescence through donor-acceptor recombination, while a thin-film-type inorganic EL element exhibits local luminescence in many cases.

Alight emitting material that can be used in the present invention contains a base material and an impurity element which serves as a luminescence center. By changing the impurity element to be contained in the light emitting material, light emission of various colors can be obtained.

As a base material of a light emitting material, sulfide, oxide, or nitride can be used. Examples of sulfide include zinc sulfide (ZnS), cadmium sulfide (CdS), calcium sulfide (CaS), yttrium sulfide (Y₂S₃), gallium sulfide (Ga₂S₃), strontium sulfide (SrS), and barium sulfide (BaS). Examples of oxide include zinc oxide (ZnO) and yttrium oxide (Y₂O₃). Examples of nitride include aluminum nitride (AlN), gallium nitride (GaN), and indium nitride (InN). Further, it is also possible to use zinc selenide (ZnSe), zinc telluride (ZnTe), or ternary mixed crystals such as calcium gallium sulfide (CaGa₂S₄), strontium gallium sulfide (SrGa₂S₄), or barium gallium sulfide (BaGa₂S₄), or the like.

For a luminescence center of an EL element which exhibits local luminescence, the following can be used: manganese (Mn), copper (Cu), samarium (Sm), terbium (Tb), erbium (Er), thulium (Tm), europium (Eu), cerium (Ce), praseodymium (Pr), and the like. Note that a halogen element such as fluorine (F) or chlorine (Cl) may also be added. A halogen element can function to compensate electric charge.

Meanwhile, for a luminescence center of an EL element which exhibits luminescence through donor-acceptor recombination, a light emitting material containing a first impurity element which forms a donor level and a second impurity element which forms an acceptor level can be used. Examples of the first impurity element include fluorine (F), chlorine (Cl), and aluminum (Al). Meanwhile, examples of the second impurity element include copper (Cu) and silver (Ag).

Note that the concentration of the impurity element with respect to the base material may be 0.01 at. % to 10 at. %, preferably, 0.05 at. % to 5 at. %.

With regard to a thin-film-type inorganic EL element, an electroluminescent layer contains the above-described light emitting material, which can be formed by a vacuum evaporation method such as a resistance heating evaporation method or an electron beam evaporation (EB evaporation) method, a physical vapor deposition (PVD) method such as a sputtering method, a chemical vapor deposition (CVD) method such as a metal organic CVD method or a low pressure hydride transport CVD method, an atomic layer epitaxy (ALE) method, or the like.

FIGS. 14A to 14C show examples of a thin-film-type inorganic EL element that can be used as a light emitting element. Each of the light emitting elements shown in FIGS. 14A to 14C includes a first electrode layer 50, an electroluminescent layer 52, and a second electrode layer 53.

The light emitting elements shown in FIGS. 14B and 14C each have a structure in which an insulating layer is provided between the electrode layer and the electroluminescent layer of the light emitting element shown in FIG. 14A. The light emitting element shown in FIG. 14B has an insulating layer 54 between the first electrode layer 50 and the electroluminescent layer 52. The light emitting element shown in FIG. 14C has an insulating layer 54a between the first electrode layer 50 and the electroluminescent layer 52, and an insulating layer 54b between the second electrode layer 53 and the electroluminescent layer 52. As described above, the insulating layer may be provided between one or each of the pair of electrode layers and the electroluminescent layer. In addition, the insulating layer can be either a single layer or a plurality of stacked layers.

Although the insulating layer 54 in FIG. 14B is provided to be in contact with the first electrode layer 50, the insulating layer 54 may also be provided to be in contact with the second electrode layer 53 by reversing the order of the insulating layer and the electroluminescent layer.

In the case of forming a dispersion-type inorganic EL element, a film-form electroluminescent layer is formed by dispersing particulate light emitting materials in a binder. A binder is a substance for fixing particulate light emitting materials to be in a dispersed state in order to keep the shape of the electroluminescent layer. Light emitting materials are uniformly dispersed and fixed in the electroluminescent layer by the binder.

The electroluminescent layer of the dispersion-type inorganic EL element can be formed by a droplet discharge method by which an electroluminescent layer can be selectively formed, a printing method (e.g., screen printing or offset printing), a coating method such as a spin coating method, a dip coating method, a dispensing method, or the like. The thickness of the electroluminescent layer is not limited to a specific value; however, it is preferably in the range of 10 nm to 1000 mm. In the electroluminescent layer which contains a light emitting material and a binder, the percentage of the light emitting material is preferably 50 wt % to 80 wt %, inclusive.

FIGS. 15A to 15C show examples of a dispersion-type inorganic EL element that can be used as a light emitting element. The light emitting element shown in FIG. 17A has a structure in which a first electrode layer 60, an electroluminescent layer 62, and a second electrode layer 63 are stacked, and the electroluminescent layer 62 contains a light emitting material 61 fixed by a binder.

As a binder that can be used in this embodiment mode, an organic material, an inorganic material, or a mixed material of an organic material and an inorganic material can be used. As an organic material, the following resins can be used: a polymer having a relatively high dielectric constant such as a cyanoethyl cellulose based resin, a polyethylene resin, a polypropylene resin, a polystyrene based resin, a silicone resin, an epoxy resin, and vinylidene fluoride. Further, it is also possible to use heat resistant polymers such as aromatic polyamide and polybenzimidazole, or a siloxane resin. Further, it is also possible to use a resin material such as a vinyl resin (e.g., polyvinyl alcohol or polyvinyl butyral), a phenol resin, a novolac resin, an acrylic resin, a melamine resin, a urethane resin, or an oxazole resin (e.g., polybenzoxazole). When high-dielectric-constant microparticles of, for example, barium titanate (BaTiO₃) or strontium titanate (SrTiO₃) are mixed as appropriate into the above-described resin, the dielectric constant of the material can be controlled.

As an inorganic material contained in the binder, the following materials can be used: silicon oxide (SiOₓ) silicon nitride (SiNₓ), silicon containing oxygen and nitrogen, aluminum nitride (AlN), aluminum containing oxygen and nitrogen, aluminum oxide (Al₂O₃), titanium oxide (TiO₂), BaTiO₃, SrTiO₃, lead titanate (PbTiO₃), potassium niobate (KNbO₃), lead niobate (PbNbO₃), tantalum oxide (Ta₂O₅), barium tantalate (BaTa₂O₆), lithium tantalate (LiTaO₃), yttrium oxide (Y₂O₃), zirconium oxide (ZrO₂), and other substances containing an inorganic insulating material. When a high-dielectric-constant inorganic material is mixed into an organic material (by doping or the like), it becomes possible to control the dielectric constant of the electroluminescent layer which contains a light emitting material and a binder more efficiently, so that the dielectric constant can be further increased. When a mixed layer of an inorganic material and an organic material is used for the binder so as to obtain a high dielectric constant, higher electric charge can be induced by the light emitting material.

The light emitting elements shown in FIGS. 15B and 15C each have a structure in which an insulating layer is provided between the electrode layer and the electroluminescent layer of the light emitting element shown in FIG. 15A. The light emitting element shown in FIG. 15B has an insulating layer 64 between the first electrode layer 60 and the electroluminescent layer 62. The light emitting element shown in FIG. 15C has an insulating layer 64a between the first electrode layer 60 and the electroluminescent layer 62, and an insulating layer 64b between the second electrode layer 63 and the electroluminescent layer 62. As described above, the insulating layer may be provided between one or each of the pair of electrode layers and the electroluminescent layer. In addition, the insulating layer can be either a single layer or a plurality of stacked layers.

In addition, although the insulating layer 64 is provided to be in contact with the first electrode layer 60 in FIG. 15B, the insulating layer 64 may also be provided to be in contact with the second electrode layer 63 by reversing the order of the insulating layer and the electroluminescent layer.

Although the insulating layers 54 in FIG. 14B and the insulating layer 64 in FIG. 15B are not particularly limited to certain types, such insulating layers preferably have a high withstand voltage and dense film quality. Further, such insulating layers preferably have a high dielectric constant. For example, the following materials can be used: silicon oxide (SiO₂), yttrium oxide (Y₂O₃), titanium oxide (TiO₂), aluminum oxide (Al₂O₃), hafnium oxide (HfO₂), tantalum oxide (Ta₂O₅), barium titanate (BaTiO₃), strontium titanate (SrTiO₃), lead titanate (PbTiO₃), silicon nitride (Si₃N₄), zirconium oxide (ZrO₂), and the like. Further, a mixed film of such materials or a stacked film containing two or more of such materials can also be used. Such insulating films can be formed by sputtering, evaporation, CVD, or the like. Further, it is also possible to form an insulating layer by dispersing particles of the materials in a binder. The binder material may be formed using a material and method similar to those of the binder contained in the electroluminescent layer. Although the thickness of such an insulating layer is not particularly limited, it is preferably in the range of 10 nm to 1000 nm.

The light emitting element shown in this embodiment mode emits light when a voltage is applied between the pair of electrode layers which sandwich the electroluminescent layer, and can be operated by either DC driving or AC driving.

An electrode layer containing a conductive polymer is used for at least one of a pair of electrode layers (the first electrode layer 50, the second electrode layer 53, the first electrode layer 60, and the second electrode layer 63) used for a light emitting element which is a display element in FIGS. 14A to 15C, and ionic impurities contained in the electrode layer containing a conductive polymer are reduced (preferably to 100 ppm or less). Of course, electrode layers containing a conductive polymer may be used for both of each pair of the electrode layers which are used for the display element, and the concentration of ionic impurities in the electrode layers containing a conductive polymer is reduced (preferably to 100 ppm or less).

An electrode layer containing a conductive polymer in which ionic impurities are reduced in this embodiment mode using the present invention may be manufactured using the same material through the same process as in Embodiment Mode 1; accordingly, Embodiment Mode 1 can be applied to the formation of the electrode layer.

In this embodiment mode, an electrode layer containing a conductive polymer is used when the first electrode layer 50, the second electrode layer 53, the first electrode layer 60, or the second electrode layer 63 is required to transmit light, and the concentration of ionic impurities in the electrode layer containing a conductive polymer is reduced (preferably to 100 ppm or less).

Note that in the present invention, at least one of a pair of electrode layers used for a display element uses an electrode layer containing a conductive polymer, and the concentration of ionic impurities contained in the electrode layer containing a conductive polymer is reduced (preferably to 100 ppm or less). Therefore, in the case where one of the electrode layers is formed so as to contain a conductive polymer, the other electrode layer may be formed of a transparent conductive film or a metal film. Since the electrode layer containing a conductive polymer is has a light-transmitting property, a reflective thin film may be used instead for an electrode layer required to be reflective or a laminate of the thin metal film and the electrode layer containing a conductive polymer may be used.

An electrode layer used for a display element, which is manufactured using a conductive composition containing a conductive polymer in this embodiment mode is an electrode layer containing a conductive polymer, and in the electrode layer containing a conductive polymer, ionic impurities which contaminate a liquid crystal material, a light-emitting material, or the like which is used for a display element are reduced (preferably to 100 ppm or less). Therefore, a display device with high reliability can be manufactured using such an electrode layer.

Further, since a wet process is employed for manufacturing an electrode layer of a display element, material utilization efficiency can be high, and a cost reduction and a productivity improvement can be achieved because expensive facilities such as a large vacuum apparatus can be reduced. Thus, according to this embodiment mode of the present invention, highly reliable display devices and electronic devices can be manufactured at low cost with improved productivity.

This embodiment mode can be combined with the above Embodiment Modes 1, 2, and 4 as appropriate.

### Embodiment Mode 7

A television set (also referred to as a TV simply or a television receiver) can be completed using a display device formed by the present invention. FIG. 19 is a block diagram showing a main structure of a television set.

FIG. 17A is a top plan view showing a structure of a display panel of the present invention, in which a pixel portion 2701 where pixels 2702 are arranged in matrix, a scan line input terminal 2703, and a signal line input terminal 2704 are formed over a substrate 2700 having an insulating surface. The number of pixels may be set in accordance with various standards: the number of pixels of XGA for RGB full-color display may be 1024×768×3 (RGB), that of UXGA for RGB full-color display may be 1600×1200×3 (RGB), and that corresponding to a full-speck high vision for RGB full-color display may be 1920×1080×3 (RGB).

Scan lines which extend from the scan line input terminal 2703 intersects with signal lines which extend from the signal line input terminal 2704, so that the pixels 2702 are arranged in matrix. Each pixel in the pixel portion 2701 is provided with a switching element and an electrode layer used for a display element, which is connected to the switching element. A typical example of the switching element is a TFT. A gate electrode layer side of the TFT is connected to the scan line, and a source or drain side thereof is connected to the signal line, so that each pixel can be controlled independently by a signal inputted externally.

FIG. 17A shows a structure of the display panel in which signals inputted to a scan line and a signal line are controlled by an external driver circuit. Alternatively, driver ICs 2751 may be mounted on the substrate 2700 by a COG (chip on glass) method as shown in FIG. 18A. Alternatively, a TAB (tape automated bonding) method may be employed as shown in FIG. 18B. The driver ICs may be ones formed over a single crystalline semiconductor substrate or may be circuits that are each formed using a TFT over a glass substrate. In FIGS. 18A and 18B, each driver IC 2751 is connected to an FPC (flexible printed circuit) 2750.

Further, in the case where a TFT provided in a pixel is formed using a semiconductor having high crystallinity, a scan line driver circuit 3702 may be formed over a substrate 3700 as shown in FIG. 17B. In FIG. 17B, a pixel portion 3701 which is connected to a signal line input terminal 3704 is controlled by an external driver circuit similar to that in FIG. 17A. In the case where a TFT provided in a pixel is formed using a polycrystalline (microcrystalline) semiconductor, a single crystalline semiconductor, or the like with high mobility, a pixel portion 4701, a scan line driver circuit 4702, and a signal line driver circuit 4704 can be formed over a substrate 4700 as shown in FIG. 17C.

In FIG. 19, a display panel can be formed in any mode as follows: as the structure shown in FIG. 17A, only a pixel portion 901 is formed, and a scan line driver circuit 903 and a signal line driver circuit 902 are mounted by a TAB method as shown in FIG. 18B or by a COG method as shown in FIG. 18A; a TFT is formed, and a pixel portion 901 and a scan line driver circuit 903 are formed over a substrate, and a signal line driver circuit 902 is separately mounted as a driver IC as shown in FIG. 17B; a pixel portion 901, a signal line driver circuit 902, and a scan line driver circuit 903 are formed over one substrate as shown in FIG. 17C; and the like.

In FIG. 19, as a structure of other external circuits, a video signal amplifier circuit 905 for amplifying a video signal among signals received by a tuner 904, a video signal processing circuit 906 for converting the signals outputted from the video signal amplifier circuit 905 into chrominance signals corresponding to colors of red, green, and blue respectively, a control circuit 907 for converting the video signal so as to be inputted to a driver IC, and the like are provided on the input side of the video signal. The control circuit 907 outputs signals to both the scan line side and the signal line side. In the case of digital driving, a signal dividing circuit 908 may be provided on the signal line side and an input digital signal may be divided into m pieces to be supplied.

Among signals received by the tuner 904, an audio signal is transmitted to an audio signal amplifier circuit 909, and the output thereof is supplied to a speaker 913 through an audio signal processing circuit 910. A control circuit 911 receives control information on a receiving station (receiving frequency) or sound volume from an input portion 912 and transmits the signal to the tuner 904 or the audio signal processing circuit 910.

A television set can be completed by incorporating the display module into a chassis as shown in FIGS. 20A and 20B. When a liquid crystal display module is used as a display module, a liquid crystal television set can be manufactured. When an EL display module is used, an EL television set can be manufactured. In FIG. 20A, a main screen 2003 is formed using the display module, and a speaker portion 2009, an operation switch, and the like are provided as its accessory equipment. Thus, a television set can be completed by the present invention.

A display panel 2002 is incorporated in a chassis 2001. With the use of a receiver 2005, in addition to reception of general TV broadcast, communication of information can also be performed in one way (from a transmitter to a receiver) or in two ways (between a transmitter and a receiver or between receivers) by connection to a wired or wireless communication network through a modem 2004. The television set can be operated by switches incorporated in the chassis or by a remote control device 2006 separated from the main body. A display portion 2007 that displays information to be outputted may also be provided in this remote control device.

In addition, in the television set, a structure for displaying a channel, sound volume, or the like may be provided by formation of a subscreen 2008 with a second display panel in addition to the main screen 2003. In this structure, the main screen 2003 and the subscreen 2008 can be formed using a liquid crystal display panel of the present invention. Alternatively, the main screen 2003 may be formed using an EL display panel superior in a viewing angle, and the subscreen 2008 may be formed using a liquid crystal display panel capable of displaying with low power consumption. In order to prioritize low power consumption, a structure in which the main screen 2003 is formed using a liquid crystal display panel, the subscreen 2008 is formed using an EL display panel, and the sub-screen is able to flash on and off may be employed. By the present invention, a highly reliable display device can be manufactured even with the use of such a large substrate, and many TFTs and electronic components.

FIG. 20B shows a television set having a large display portion, for example, 20 to 80-inch display portion, which includes a chassis 2010, a display portion 2011, a remote control device 2012 which is an operation portion, a speaker portion 2013, and the like. The present invention is applied to manufacture of the display portion 2011. The television set shown in FIG. 20B is a wall-hanging type, and does not need a wide space. Since an electrode layer used for a display element in accordance with the present invention can be formed by a wet process, even a television set having such a large display portion as in FIGS. 20A and 20B can be manufactured at low cost with high productivity.

Needless to say, the present invention is not limited to the television set and is also applicable to various uses such as a monitor of a personal computer, or in particular, a display medium with a large area, for example, an information display board at a train station, an airport, or the like, or an advertisement display board on the street.

This embodiment mode can be combined with any of Embodiment Modes 1 to 7 as appropriate.

### Embodiment Mode 8

Examples of electronic devices in accordance with the present invention are as follows: a television device (also referred to as simply a television, or a television receiver), a camera such as a digital camera or a digital video camera, a cellular telephone device (simply also referred to as a cellular phone or a cell-phone), a portable information terminal such as PDA, a portable game machine, a computer monitor, a computer, a sound reproducing device such as a car audio system, an image reproducing device including a recording medium, such as a home-use game machine, and the like. Further, the present invention can be applied to various amusement machines each having a display device, such as a pachinko machine, a slot machine, a pinball machine, and a large game machine. Specific examples of them are described with reference to FIGS. 21A to 21E

A portable information terminal device shown in FIG. 21A includes a main body 9201, a display portion 9202, and the like. The display device of the present invention can be applied to the display portion 9202. As a result, a high-performance and high reliability portable information terminal device which can display a high-quality image can be provided.

A digital video-camera shown in FIG. 211B includes a display portion 9701, a display portion 9702, and the like. The display device of the present invention can be applied to the display portion 9701. As a result, a high-performance and high reliability digital video camera which can display a high-quality image can be provided.

A cellular phone shown in FIG. 21C includes a main body 9101, a display portion 9102, and the like. The display device of the present invention can be applied to the display portion 9102. As a result, a high-performance and high reliability cellular phone which can display a high-quality image can be provided.

A portable television device shown in FIG. 21D includes a main body 9301, a display portion 9302 and the like. The display device of the present invention can be applied to the display portion 9302. As a result, a high-performance and high reliability portable television device which can display a high-quality image can be provided. The display device of the present invention can be applied to a wide range of television devices ranging from a small-sized television device mounted on a portable terminal such as a cellular phone, a medium-sized television device which can be carried, to a large-sized (for example, 40-inch or larger) television device.

A portable computer shown in FIG. 21E includes a main body 9401, a display portion 9402, and the like. The display device of the present invention can be applied to the display portion 9402. As a result, a high-performance and high reliability portable computer which can display a high-quality image can be provided.

A slot machine shown in FIG. 21F includes a main body 9501, a display portion 9502, and the like. The display device of the present invention can be applied to the display portion 9502. As a result, a high-performance and high reliability slot machine which can display a high-quality image can be provided.

The display device using a self-light emitting element as a display element (a light emitting display device) in the present invention can be used as a lighting system. The display device to which the present invention is applied can also be used as a small table lamp or a large-scale lighting system in a room. Further, the light emitting display device of the present invention can also be used as the backlight of a liquid crystal display device. The light emitting display device of the present invention is used as the backlight of the liquid crystal display device, so that the liquid crystal display device can achieve higher reliability. The light emitting display device of the present invention is a plane-emission lighting system and can have a large area; therefore, backlight can have a large area and the liquid crystal display device can also have a large area. Further, since the light emitting display device of the present invention is thin, the liquid crystal display device can be made to be thin.

As described above, a high-performance and high reliability electronic device which can display a high-quality image can be provided by using the display device of the present invention.

This embodiment mode can be combined with any of Embodiment Modes 1 to 7 as appropriate.

This application is based on Japanese Patent Application serial no. 2007-153096 filed with Japan Patent Office on Jun. 8, 2007, the entire contents of which are hereby incorporated by reference.

1. A display device comprising a display element having a pair of electrode layers,
wherein at least one of the pair of electrode layers contains a conductive polymer, and
concentration of ionic impurity in the at least one of the pair of electrode layers containing a conductive polymer is 100 ppm or less.

2. A display device according to claim 1,
wherein the display element has a liquid crystal layer, and
the pair of electrode layers and the liquid crystal layer are stacked with insulating layers serving as alignment films therebetween.

3. A display device according to claim 1,
wherein the display element has an electroluminescent layer, and
the pair of electrode layers and the electroluminescent layer are in contact with each other.

4. A display device according to claim 1,
wherein an anion of the ionic impurity is an ion of an element having an ionization energy of 6 eV or less.

5. A display device according to claim 1,
wherein an anion of the ionic impurity is an ion of one of an alkali metal and an alkaline earth metal.

6. A display device according to claim 1,
wherein a cation of the ionic impurity is included in an inorganic acid.

7. A display device according to claim 1,
wherein the conductive polymer is any one of polythiophene, polyaniline, polypyrrole, and a derivative thereof.

8. A display device according to claim 1,
wherein at least one of the pair of electrode layers includes an organic resin.

9. A display device according to claim 1,
wherein at least one of the pair of electrode layers has one of an organic acid, an organic cyano compound and a mixture thereof as a dopant.

10. A display device comprising a display element having a pair of electrode layers,
wherein the pair of electrode layers each contain a conductive polymer, and
concentration of ionic impurity in the pair of electrode layers each containing a conductive polymer is 100 ppm or less.

11. A display device according to claim 10,
wherein the display element has a liquid crystal layer, and
the pair of electrode layers and the liquid crystal layer are stacked with insulating layers serving as alignment films therebetween.

12. A display device according to claim 10,
wherein the display element has an electroluminescent layer, and
the pair of electrode layers and the electroluminescent layer are in contact with each other.

13. A display device according to claim 10,
wherein an anion of the ionic impurity is an ion of an element having an ionization energy of 6 eV or less.

14. A display device according to claim 10,
wherein an anion of the ionic impurity is an ion of one of an alkali metal and an alkaline earth metal.

15. A display device according to claim 10,
wherein a cation of the ionic impurity is included in an inorganic acid.

16. A display device according to claim 10,
wherein the conductive polymer is any one of polythiophene, polyaniline, polypyrrole, and a derivative thereof.

17. A display device according to claim 10,
wherein at least one of the pair of electrode layers includes an organic resin.

18. A display device according to claim 10,
wherein at least one of the pair of electrode layers has one of an organic acid, an organic cyano compound and a mixture thereof as a dopant.

19. A display device comprising:
a first electrode provided over a substrate;
an electroluminescent layer provided over the first electrode; and
a second electrode provided over the electroluminescent layer,
wherein the first electrode and the second electrode each contain a conductive polymer, and
concentration of ionic impurity in the first electrode and the second electrode each containing a conductive polymer is 100 ppm or less.

20. A display device according to claim 19,
wherein an anion of the ionic impurity is an ion of an element having an ionization energy of 6 eV or less.

21. A display device according to claim 19,
wherein an anion of the ionic impurity is an ion of one of an alkali metal and an alkaline earth metal.

22. A display device according to claim 19,
wherein a cation of the ionic impurity is included in an inorganic acid.

23. A display device according to claim 19,
wherein the conductive polymer is any one of polythiophene, polyaniline, polypyrrole, and a derivative thereof.

24. A display device according to claim 19,
wherein at least one of the first electrode and the second electrode includes an organic resin.

25. A display device according to claim 19,
wherein at least one of the first electrode and the second electrode has one of an organic acid, an organic cyano compound and a mixture thereof as a dopant.
